(19) United States
(12) Patent Application Publication
(10) Pub. No.: US 2019/0092081 A1
(43) Pub. Date: Mar. 28, 2019

(54) Security Element and Method for Producing a Security Element

(71) Applicants: LEONHARD KURZ Stiftung & Co. KG, Furth (DE); OVD Kinegram AG, Zug (CH)

(72) Inventors: Wayne Robert Tompkin, Baden (CH); Markus Burkhardt, Zirndorf (DE); Norbert Lutz, Ruckersdorf (DE); Harald Walter, Horgen (CH); Andreas Schilling, Hagendorn (ZG) (CH)

(21) Appl. No.: 16/083,207

(22) PCT Filed: Feb. 27, 2017
(86) PCT No.: PCT/EP2017/054514

§ 371 Date: Sep. 7, 2018

(30) Foreign Application Priority Data
Mar. 9, 2016 (DE) 10 2016 104 300.1
May 25, 2016 (DE) 10 2016 109 632.6

(51) Int. Cl. B42D 25/328; B42D 25/324; B42D 25/373; B42D 25/41; G03H 1/00; G03H 1/02; G03H 1/22; G03H 1/26

(52) U.S. Cl. CPC B42D 25/328; B42D 25/324; B42D 25/373; B42D 25/41; B42D 25/24; G03H 1/0248; G03H 1/0236; G03H 1/2202; G03H 1/2645; G03H 1/0011

(57) ABSTRACT

A security element with a first volume hologram layer, which spans a coordinate system with the coordinate axes x and y perpendicular to each other in an unbent state of the security element, wherein a first volume hologram is introduced into the first volume hologram layer in at least one first area, wherein the first volume hologram is formed such that a first item of information is visible for an observer in a first observation situation in a first predefined bent state of the security element and is not visible in the first observation situation in the unbent state of the security element or vice versa.

The invention relates to a security element, a method for producing a security element, as well as a security document with a security element.

Optically active security elements are used in particular on security documents, such as for instance banknotes, passports, identity cards, check cards, credit cards, visas or certificates, for both information and decorative purposes. Such security elements on the one hand increase the protection against forgery, for example vis-à-vis modern color copying and other reproduction systems, and on the other hand can be easily and clearly recognized by the layperson, with the result that the layperson can clearly determine the authenticity of a security document provided with such a security element and can thus recognize forgeries or manipulations.

For this purpose, security elements often have light-diffracting, diffractive structures such as for example holograms. These security elements offer the observer effects that are optically variable when the security element is tilted. Optically variable thin-film elements which, when tilted, give the observer different color impressions, in particular as color changes, are also often used as security elements. However, such security elements are nowadays to be found on a multitude of security documents, such as for example banknotes, with the result that the layperson now hardly pays attention to them in everyday use, whereby forgeries or manipulations are recognized less often, in particular by laypeople.

The object of the invention is now to provide a security element, as well as a method for producing a security element, which is characterized by a novel optically variable effect which differs from the known optically variable effects described previously.

This object is achieved by a security element with a first volume hologram layer which spans a coordinate system with the coordinate axes x and y perpendicular to each other in an unbent state of the security element, wherein a first volume hologram is introduced into the first volume hologram layer in at least one first area, wherein the first volume hologram is formed such that a first item of information is visible for an observer in a first observation situation in a first predefined bent state of the security element and is not visible in the first observation situation in the unbent state of the security element or vice versa. This object is further achieved by a method for producing a security element with a first volume hologram layer, in particular according to one of claims 1 to 43, wherein the method comprises the following steps: a) providing the first volume hologram layer; b) arranging a first master with a first surface structure on the first volume hologram layer; c) exposing the first master and the first volume hologram layer by means of coherent light, wherein the first volume hologram introduced into the first volume hologram layer in this way is formed such that a first item of information is visible for an observer in a first observation situation in a first predefined bent state of the security element and is not visible in the first observation situation in the unbent state of the security element or vice versa. This object is also achieved by a security document with a security element according to one of claims 1 to 43.

The invention is based on the recognition that, by the forming of the above-specified volume hologram layer, an optically variable effect can be generated which differs from the above-named known optically variable effects. Whereas in the case of previous security elements an optically variable effect appeared during a tilting of the security elements, here an optically variable effect is produced by a bending of the security element, with the result that, for example, an item of information only becomes visible for the observer, in the bent state of the security element. This produces a surprising novel impression on an observer, which differs from the known optically variable effects. In particular, the optically variable effect which is to be seen during bending, clearly differs from an optical effect of the volume hologram during tilting. Depending on the design of the volume hologram, the optically variable effect according to the invention can occur, for example, both in the case of a “bending towards” and in the case of a “bending away”. The curiosity of the observer is hereby awakened, whereby the security element is observed more often and forgeries are thus recognized more often. Because the optically variable effect occurs only during bending (and not during tilting) of the security element, a clear identification of the effect, which is further characterized by being highly memorable, is made possible in particular for the layperson. The observer can for example intuitively check the authenticity of a security document with the security element according to the invention by bending. Here, it is advantageous that in particular security documents such as for example identity documents, passport documents, visas, banknotes or securities are flexible or bendable and are also often bent in everyday use, with the result that attention to this optical effect is further increased for users of the security documents with the security element according to the invention. The protection against forgery is further increased by the security element according to the invention, as a forger now also has to take into consideration a bent state of the security element during a potential counterfeiting. Furthermore, because of the volume hologram, the security element cannot be copied by molding a surface relief.

Unlike embossed holograms, in which the item of information is applied only as a relief to the surface of a film and via which incident light is diffracted—in a “volume hologram” in particular the items of information are stored in the material volume. In this material volume as recording medium, via a modulation of at least two coherent waves, superimposition of these waves occurs. The resulting interference patterns are stored in the material volume of the volume hologram in so-called Bragg planes and contain the holographic information as a variation of the refractive index of the material. During reconstruction of the volume hologram, the stored information of the object wave is read. During bending on a volume hologram, the Bragg condition applies, with the result that a volume hologram can be reconstructed only by reference beams with quite specific angles of incidence and wavelengths. The Bragg condition is n λ=2d sin θ, wherein n is a natural number, λ the wavelength and d the distance between the Bragg planes. The complementary angle θ is called the Bragg angle or glancing angle and is calculated from the angle of incidence measured from the perpendicular as follows: θ=90−α.

By “bending” is meant here the deformation of an object in a specific manner by exertion of a force. By “ bending” of a security element is therefore meant the exertion of force on the security element, wherein the shape of the security element is changed or can be changed by the application of force. A bent security element thus has a changed geometry in comparison with the unbent security element. Furthermore, by “bending” is also meant a kinking, with the result that a bent security element can have one or more kink points or kink lines, at which the security element is sharply or abruptly bent.

By “bent state” of the security element is meant here a bent security element. This means that the shape of a security element in a bent state has been changed by the application of force. Preferably, the security element is curved or kinked in the bent state and is flat or plane in the unbent state.

By “predefined” is meant here a predetermined value or range of values, or a predetermined shape or geometry. Thus, for example, a security element in a predefined bent state conforms to the shape of a parabola, wherein the parameters describing the parabola for the predefined bent state are fixed within tolerance limits.

By “observation situation” is meant here the positional relationships of the observer, an illumination device and the security element to each other. This means that in a specific observation situation the positional relationships to each other do not change. Thus, for example, the distances or angular relationships of the observer, the illumination device and the security element to each other remain substantially identical in a specific observation situation.

By “visible” is meant here that the item of information is recognizable for the observer, in particular under normal lighting conditions and at a normal observation distance. By “not visible” is meant here that the item of information is not recognizable for the observer, in particular under normal lighting conditions and at a normal observation distance. Preferably, by “not visible” is also meant only slightly visible. Thus it is possible that the “not visible” information is only slightly recognizable for the observer, in particular in comparison with the “visible” information.

By “area” is meant here in each case a defined surface area of a layer, which is occupied during observation perpendicular to a plane spanned by the first volume hologram layer. Preferably, the defined surface area occupied by the area is determined in the unbent state of the security element.

Further advantageous embodiments of the invention are described in the dependent claims.

It is possible that the first volume hologram is formed such that at least one second item of information is visible for the observer in the first observation situation in at least one second predefined bent state of the security element and is not visible in the first observation situation in the unbent state of the security element or vice versa. It is hereby achieved that a second item of information becomes visible for the observer in the first observation situation in a second predefined bent state of the security element. Preferably, the first and the second items of information complement each other here, with the result that, for an inexperienced observer, an image that is logically to be expected, or a sequence of images that is logically to be expected, arises from the combination of the first and second items of information. The first item of information can here be visible in the first and in the second predefined bent state. Thus, the observer can for example see a closed blossom in the first bent state of the security element and an opened blossom in the second bent state of the security element. Thus, it is possible that a motif which is recognizable for the observer in the first bent state of the security element changes during bending of the security element into the second bent state. A picture story, for example, can hereby be produced for the observer, which is also intuitive and self-explanatory for the layperson. During bending, the observer is “rewarded” by the discovery of the picture story. Furthermore, the protection against forgery is further increased, as a forger now has to consider several bent states. An example of such a picture story is an image which is put together piece by piece, like a puzzle, during bending.

Advantageously, in the first and/or the at least one second predefined bent state the security element is bent around the x-axis and/or the y-axis. Thus it is possible that in the first and/or the at least one second predefined bent state the security element is bent around a horizontal and/or vertical axis of the security element. By a bending around the x-axis and/or y-axis is also meant a bending relative to a line parallel to one of these axes.

Preferably, in the first and/or the at least one second predefined bent state the security element is bent towards the observer, in particular such that the security element has a concave shape in the first and/or the at least one second predefined bent state, and/or the security element is bent away from the observer, in particular such that the security element has a convex shape in the first and/or the at least one second predefined bent state.

It is further possible that the first and/or the at least one second predefined bent state of the security element approximately conforms to the shape of a half-parabola or of a parabola.

Preferably, the security element has at least one bending line around which the security element is bent in the first and/or the at least one second predefined bent state of the security element. Preferably the bending line lies in the at least one first area, in which the first volume hologram is introduced into the first volume hologram layer.

It is further possible that the thickness of the security element is reduced in an area of the bending line. Thus it is possible that the thickness of the first volume hologram layer is reduced in the area of the bending line, preferably by at least 1 μm, by preference by at least 2.5 μm, further preferably by at least 5 μm, even further preferably by at least 10 μm. It is also possible that the thicknesses of one or more further layers of the security element, in particular a carrier layer and/or a protective varnish layer, are reduced in the area of the bending line. It is further possible that at least one of the layers of the security element is not present in the area of the bending line, with the result that the thickness of the security element is reduced hereby. It is further possible that perforations or other local holes in the security element and/or the security document are arranged in the area of the bending line. The width of the area with reduced thickness of the security element is preferably between 5 μm and 10 mm, preferably between 50 μm and 5 mm, further preferably between 100 μm and 5 mm. It is hereby possible that the security element is bent along a bending line, the position of which on the security element is predefined by the reduction in thickness.

It is further possible that the security element is bent symmetrically or asymmetrically with respect to the bending line in the first and/or the at least one second predefined bent state.

By “symmetrically” is preferably meant here a geometric symmetry, with the result that the security element symmetrically bent in the first and/or the at least one second predefined bent state can be mapped onto itself by movement. Thus it is possible that the security element symmetrically bent in the first and/or the at least one second predefined bent state is bent as a mirror image with respect to the bending line. By “asymmetrically” is preferably meant here a bending in the first and/or the at least one second bent state which is not symmetrical.

It is also possible that the angles enclosed between a surface of the security element and one of the coordinate axes x or y are different on both sides of the bending line in the first and/or the at least one second predefined bent state of the security element when the security element is observed parallel to a plane spanned by the coordinate axes x and y.

Preferably, the angles enclosed between a surface of the security element and one of the coordinate axes x or y are substantially identical on both sides of the bending line in the unbent state of the security element when the security element is observed parallel to a plane spanned by the coordinate axes x and y, in particular the angles differ by less than 5°, preferably by less than 2.5°, further preferably by less than 1°.

It is further possible that, if the Laplace operator Δ is applied to a surface of the security element described by a function F(x,y), a predefined limit value is exceeded in the first and/or the at least one second predefined bent state of the security element and is not exceeded in the unbent state, wherein the function F(x,y) describes the distance from the surface of the security element to a two-dimensional reference surface spanned by the coordinate axes x and y. It is also possible that if the Laplace operator Δ is applied to the function F(x,y), a further predefined limit value is not exceeded in the first and/or the at least one second predefined bent state of the security element, with the result that if the Laplace operator Δ is applied to the function F(x,y), the first and/or the at least one second predefined bent state is determined by a range of values which lies between the predefined limit value and the further predefined limit value.

According to a further preferred embodiment example, the bending radius in the first and/or the at least one second predefined bent state of the security element lies between 1 mm and 100 mm, preferably between 2 mm and 50 mm, further preferably between 4 mm and 30 mm.

By “bending radius” is meant here the radius r of the largest circle which lies tangential to the bending line or the bending point, and at the same time has no points of intersection with the security element and/or security document. An unbent, flat security element consequently has an infinite bending radius.

It is further advantageous that the bending radius in the first and the at least one second predefined bent state of the security element differs by at least 2 mm, preferably 5 mm, further preferably 10 mm.

Furthermore, it is expedient that the security element is bendable, preferably easily and reversibly bendable, in particular that the shape of the security element can be changed by application of force, preferably small application of force.

Preferably, in the direction of the coordinate axis x or y around which the security element is bent in the first and/or the at least one second predefined bent state, the security element has a length of at least 5 mm, preferably of at least 10 mm, further preferably of at least 20 mm, even further preferably of at least 50 mm.

Advantageously, the security element has an areal extent in the unbent state of the security element of at least 5 mm×1 mm, preferably of at least 10 mm×2 mm, even further preferably of at least 50 mm×10 mm.

According to a further preferred embodiment example, in the at least one first area the first volume hologram has two or more first zones, wherein the two or more first zones in the first predefined bent state of the security element provide the first item of information for the observer in the first observation situation. It is hereby possible that the first item of information is generated in the first observation situation by the two or more first zones of the at least one first area.

It is further possible that in the at least one first area the first volume hologram has two or more second zones, wherein the two or more second zones in the at least one second predefined bent state of the security element provide the at least one second item of information for the observer in the first observation situation. It is hereby possible that the at least one second item of information is generated in the first observation situation by the two or more second zones of the at least one first area.

It is advantageous here if the two or more first zones and/or the two or more second zones have a length in the unbent state of the security element of at least 5 μm, preferably 50 μm, even further preferably 500 μm in the direction of one of the coordinate axes x and/or y.

It is further possible that the two or more first zones and/or the two or more second zones have an areal extent in the unbent state of the security element of at least 5 μm×5 μm, preferably of 50 μm×50 μm, even further preferably of 500 μm×500 μm.

It is further expedient if the two or more first zones and/or the two or more second zones are arranged according to a grid.

Here it is possible that the grid is a one-dimensional grid, in particular a line grid, or a two-dimensional grid, in particular a dot grid. By dot grid is also meant here a pixel grid of square, in particular rectangular or quadratic areas of surface.

It is further possible that the two or more first zones and/or the two or more second zones are gridded in each other. It is thus possible that the two or more first zones are arranged alternating with the two or more second zones, and that the two or more first zones are arranged adjacent to the two or more second zones.

Furthermore, it is possible that the grid width is smaller than the resolution limit of the naked human eye, in particular that the grid width is smaller than 300 μm, preferably smaller than 150 μm.

Advantageously, the two or more first zones and/or the two or more second zones are arranged on both sides of the bending line. Thus it is possible, for example, that at least one of the first zones lies on a first side of the bending line and at least one of the first zones lies on a second side of the bending line.

Preferably, in the first predefined bent state of the security element the two or more first zones and/or in the at least one second predefined bent state of the security element the two or more second zones are visible for the observer in the first observation situation at different illumination angles or observation angles.

By observation angle is meant the angle enclosed between the plane spanned by the first volume hologram layer in the unbent state and the observation direction of an observer. Likewise, by illumination angle is meant the angle enclosed between the plane spanned by the first volume hologram layer in the unbent state and the illumination direction of an illumination device. If the security element is bent, in the two or more first and/or second zones the observation angle and the illumination angle thus change for the respective zone.

According to a further preferred embodiment example, the first volume hologram layer has Bragg planes formed by refractive index variations.

Advantageously, at least one of the parameters: distance between the Bragg planes and alignment of the Bragg planes differs in the two or more first zones and/or in the two or more second zones. It is hereby made possible, for example, that the two or more first zones and/or the two or more second zones appear in different colors for the observer. It is further determined, for example, by the alignment of the Bragg planes, whether the two or more first zones and/or the two or more second zones are visible for the observer in the first and/or at least one second predefined bent state.

It is advantageous here if the distance between the Bragg planes differs by more than 5 nm, preferably more than 10 nm, even further preferably by more than 20 nm, and/or if the angles enclosed by the Bragg planes and the first volume hologram layer differ by more than 2°, preferably by more than 5°, further preferably by more than 10°, even further preferably by more than 20°.

Preferably, the alignments of the Bragg planes in the two or more first zones are substantially identical to each other in the first predefined bent state of the security element. It can hereby be achieved that each of the two or more first zones contributes to generating the first item of information in the first observation situation in the first predefined bent state of the security element. Furthermore, this has the consequence that the alignments of the Bragg planes in the two or more first zones are not identical to each other in the flat state.

It is further possible that the alignments of the Bragg planes in the two or more second zones are substantially identical to each other in the second predefined bent state of the security element. It can hereby be achieved that each of the two or more second zones contributes to generating the at least one second item of information in the first observation situation in the at least one second predefined bent state of the security element. Furthermore, this has the consequence that the alignments of the Bragg planes in the two or more second zones are not identical to each other in the flat state.

Furthermore, it is possible that in the first predefined bent state of the security element in the two or more first zones and/or in the at least one second predefined bent state in the two or more second zones of the security element the angles enclosed between the normals to the Bragg planes and the direction of the incident light are substantially identical to the angles enclosed between the normals to the Bragg planes and the direction of the light reflected and/or diffracted by the Bragg planes.

Preferably, for producing a security element a first master is used, which is generated starting from a bent intermediate master, wherein the bending of the bent intermediate master corresponds to the bending of the first and/or of the at least one second predefined bent state of the security element. The intermediate master can, for example, be a film with a holographically exposed photoresist, wherein the film is bent during the holographic exposure corresponding to the bending of the first and/or of the at least one second predefined bent state of the security element.

It is further possible that a first master is used, which is produced by means of distorting optics, in particular cylindrical lenses. Here, the distorting optics expose the first master such that the first volume hologram introduced into the first volume hologram layer by means of the first master is formed such that the first and/or the at least one second item of information is visible for an observer in a first observation situation in the first and/or the at least one second predefined bent state of the security element and is not visible in the first observation situation in the unbent state of the security element or vice versa.

It is further possible that for producing a security element a first master is used, which contains a computer-generated hologram (CGH), wherein this CGH is calculated for a curved surface area corresponding to the bending of the first and/or of the at least one second predefined bent state of the security element. The curvature of the bent security element is thus compensated for in the calculated CGH.

It is also possible that a first master is used, the first surface structure of which comprises a Kinegram®, a symmetrical grating, an asymmetrical grating, in particular a blazed grating, a binary grating, a multi-level phase grating, isotropic or anisotropic matte structures, a retroreflective structure, a macrostructure with a (substantially) refractive effect, in particular a microprism structure or a micromirror, in particular Fresnel-like or also otherwise designed freeform surfaces, or combinations thereof. In addition, grating structures with statistically varying parameters (grating period, profile shape, grating depth, azimuthal alignment) can advantageously be provided here. In particular, blazed gratings are suitable, the flank angles of which are designed for the illumination and observation angles of the corresponding zones of the security element in the first and/or at least one second predefined bent state.

Here the depth t of the blazed gratings is preferably optimized for the wavelength for which the first volume hologram is designed, according to the following formula:

t=n×λ/2 with: n∈N

At the same time, however, the depth t should preferably not be greater than the period of the blazed gratings.

Furthermore, it is advantageous that a first master is used, which has at least two partial areas, which reflect or diffract incident light into at least two different zones of the first volume hologram layer.

Preferably, the first surface structure of the first master differs in the at least two partial areas, in particular in at least one of the parameters: profile shape, grating depth, grating period and azimuthal angle.

It is possible that the first master has a symmetrical grating structure in a first partial area and a first asymmetrical grating structure in a second partial area, wherein the grating periods and/or grating depths of the grating structures in the first and second partial areas differ.

It is further possible that the first master has a second asymmetrical grating structure in a third partial area, wherein the grating periods and/or grating depths of the first and second asymmetrical grating structures differ.

It is advantageous that the first volume hologram layer and the first master are exposed by coherent light beams of different wavelengths and/or different directions of incidence.

The coherent light beam advantageously passes through the first volume hologram layer and is diffracted or reflected at the first surface structure of the first master. Here the master is, in particular, the object to be reconstructed.

It makes sense that the first master is arranged on the first volume hologram layer directly or with the interposition of a transparent optical medium.

Preferably, the exposure is effected with laser light with a power density in the range from 0.5 to 5 W/cm² or with an energy density in the range from 5 to 50 mJ/cm², particularly preferably with a power density in the range from 1 to 3 W/cm² or with an energy density in the range from 10 to 30 mJ/cm².

It is further expedient that after the exposure the first volume hologram layer is fixed by curing, in particular by means of UV radiation.

According to a further preferred embodiment example, a second volume hologram is introduced into the first volume hologram layer in at least one second area.

Preferably, the second volume hologram is formed such that a third item of information is visible in the first observation situation in the unbent state of the security element. It is hereby possible that the observer in the first observation situation perceives the third item of information, for example an image of a sun, in the unbent state of the security element and perceives the first item of information, for example an image of a cloud and a sun, in the first bent state of the security element.

Advantageously, the at least one first area and the at least one second area are gridded in each other, in particular the at least one first area is arranged alternating with the at least one second area and the at least one first area is arranged adjacent to the at least one second area.

It is also possible that the security element has a third volume hologram in a second volume hologram layer. It is thus possible that the method further comprises the following steps, which are carried out in particular after steps a) to c): d) applying a second volume hologram layer; e) arranging a second master with a second surface structure on the second volume hologram layer; f) exposing the second master and the second volume hologram layer by means of coherent light, with the result that in this way a third volume hologram is introduced into the second volume hologram layer.

Preferably, in the unbent state of the security element the first volume hologram layer and the second volume hologram layer are arranged one above the other during observation perpendicular to a plane spanned by the first volume hologram layer of the security element.

Furthermore, it is possible to arrange further volume hologram layers, in particular a third, fourth, fifth volume hologram layer one above another, like the first and the second volume hologram layers. Thus it is possible that the security element has at least one third volume hologram in at least one second volume hologram layer.

It is further possible that the first volume hologram in the first volume hologram layer and the third volume hologram in the second volume hologram layer are aligned with register accuracy relative to each other.

It is further advantageous that the third volume hologram is formed such that a fourth item of information is visible for an observer in the first observation situation in a third predefined bent state of the security element and is not visible in the first observation situation in the unbent state of the security element or vice versa. It is hereby possible, for example, that the security element shows the first item of information and/or the at least one second item of information in the first observation situation in the first and/or at least one second bent state and shows the fourth item of information in the first observation situation in the third bent state. For example, the first and/or at least one second item of information can be recognizable in the case of a concavely bent shape of the security element and the third item of information can be visible in the case of a convexly bent shape of the security element. However, it is also possible that the second volume hologram is formed such that a fifth item of information is visible in the first observation situation in the unbent state of the security element. It is hereby possible that the observer perceives the fifth item of information in the first observation situation in the unbent state of the security element and perceives the first item of information in the first bent state of the security element.

With respect to possible embodiments of the second master and/or further masters, as well as the steps of arranging the second master and exposing the second master and/or further masters and the second and/or further volume hologram layers, reference is made here to the corresponding embodiments relating to the first master.

Furthermore, it is advantageous if, in at least one third area, the security element comprises a relief structure selected from the group: diffractive grating, Kinegram® or hologram, blazed grating, binary grating, multi-level phase grating, linear grating, cross grating, hexagonal grating, asymmetrical or symmetrical grating structure, retroreflective structure, in particular binary or continuous Fresnel-type freeform surfaces, diffractive or refractive macrostructure, in particular lens structure or microprism structure, microlens, microprism, zero-order diffraction structure, moth-eye structure or anisotropic or isotropic matte structure, or a superimposition or combinations of two or more of the above-named relief structures. Further, grating structures with statistically varying parameters (grating period, profile shape, grating depth, azimuthal alignment) can in addition preferably be provided.

It is hereby possible to combine the first and/or at least one second and/or fourth items of information, which are visible depending on a bending of the security element, in particular in the first and/or at least one second and/or third predefined bent state of the security element, with optical effects produced by the relief structures, the visibility of which has no, or only a slight dependence on a bending. The effect is hereby achieved, for example, that an optical effect produced by the relief structures, in particular by diffractive lenses, and/or by binary or continuous freeform surfaces and/or by a retroreflective structure, is visible in the unbent state of the security element, and is complemented by the first item of information in the first bent state, wherein the characteristic appearance of the optical effect produced by the relief structure does not change, or changes only slightly, in the first predefined bent state.

It is further possible here that the security element comprises a replication varnish layer. The replication varnish layer consists, for example, of a thermoplastic varnish, into which a relief structure is molded by means of heat and pressure by the action of a stamping tool. It is further also possible that the replication varnish layer is formed by a UV-crosslinkable varnish and the relief structure is molded into the replication varnish layer by means of UV replication. The relief structure is molded onto the uncured replication varnish layer by the action of a stamping tool and the replication varnish layer is cured before and/or directly during and/or after the molding by irradiation with UV light. Preferably, the relief structure is molded into the replication varnish layer in the at least one third area. It is further advantageous that the replication varnish layer has a layer thickness between 0.2 μm and 4 μm, preferably 0.3 μm and 2 μm, further preferably 0.4 μm and 1.5 μm.

Preferably, the security element has a reflective layer in at least one fourth area. The reflective layer is preferably a metal layer made of aluminum, chromium, gold, copper, silver or an alloy of such metals which is vapor-deposited under vacuum in a layer thickness of 0.01 μm to 0.15 μm. The reflective layer can, however, also in principle be a non-metal layer. The reflective layer can be a printed or high-resolution structured color layer or another layer which absorbs radiation, in particular in the visible spectral range. The reflective layer is formed, in particular, as a color layer. The color layer is, in particular, produced by means of the HD-Demet process.

The reflective layer can be applied over the whole surface or also only in areas, in particular as a partial metallization. For this, the reflective layer can, for example, be applied over the whole surface and then removed again in areas of the surface by means of known structuring processes (for example by means of etch resist, by means of photoresist, by means of washing processes). Such a partial metallization can, for example, be a KINEGRAM® or a metallic nanotext.

Preferably, the reflective layer is formed gridded. According to a preferred embodiment example, the partially metalized reflective layer is formed in the form of a grid. Alternatively, the gridded reflective layer can also be non-metallic and, in particular, consist of a printed or high-resolution structured color layer.

Preferably, the at least one first and/or second and/or third and/or fourth areas are aligned with register accuracy relative to each other. Particularly preferably, the items of information which the respective areas represent complement each other here.

By register or registration and register accuracy or registration accuracy is meant a positional accuracy of two or more elements and/or layers relative to each other. The register accuracy is to range within a predetermined tolerance and be as low as possible. At the same time, the register accuracy of several elements and/or layers relative to each other is an important feature in order to increase the process reliability. The positionally accurate positioning can be effected in particular by means of sensorially, preferably optically, detectable registration marks or register marks. These registration marks or register marks can either represent specific separate elements or areas or layers or themselves be part of the elements or areas or layers to be positioned.

The first volume hologram in the first volume hologram layer can also preferably be formed not over the whole surface, but in the form of a grid, i.e. only in areas. It is thus possible that the first volume hologram is arranged according to a grid. Advantageously, the first volume hologram is arranged such that the respective areas of the first volume hologram are arranged congruent in register with the metalized areas of the reflective layer. Preferably, the first volume hologram is here arranged below the reflective layer, in particular with respect to the observation direction of the security element. It is further advantageous if the grid of the first volume hologram is formed as a line grid. In the unbent state of the security element the reflective layer thus covers the first volume hologram, whereby the first volume hologram is substantially not visible. On the other hand, in the first and/or at least one second predefined bent state of the security element the reflective layer no longer completely covers the first volume hologram, with the result that the first volume hologram becomes visible or at least partially visible.

Preferably, a transparent spacing layer is arranged between the first volume hologram layer and the reflective layer, in particular between the first volume hologram layer and the reflective layer that is partially metalized and/or formed gridded.

According to a further preferred embodiment example the security element has two reflective layers in the form of a grid, preferably partially metalized, between which a transparent spacing layer is preferably arranged. Furthermore, a further spacing or varnish layer can be arranged between the reflective layers and the volume hologram layer.

The two reflective layers are preferably arranged offset relative to each other, such that the transparent areas of one reflective layer are covered by the existing or present, in particular the metalized, areas of the other reflective layer, in particular during observation perpendicular to a plane spanned by the first volume hologram layer in the unbent state of the security element. The two reflective layers are, so to speak, positioned “with a gap” relative to each other. The two reflective layers are thereby arranged with respect to each other such that in the unbent state of the security element they completely cover the underlying, for example whole-surface, first volume hologram, with the result that the first volume hologram is therefore substantially not visible for the observer. On the other hand, in the first and/or at least one second predefined bent state of the security element the reflective layers no longer cover the first volume hologram, with the result that the latter becomes visible or at least partially visible. By transparent areas in connection with in the form of a grid is meant in the present case, in particular, areas where the reflective layer is not present.

The grid of the reflective layer and/or of the reflective layers and/or of the first volume hologram is advantageously a regular grid. However, it is also possible that it is an irregular grid.

The grid of the reflective layer and/or of the reflective layers and/or the grid of the first volume hologram is preferably formed as a line grid. The lines of the line grid preferably run parallel to the bending line of the security element. The line widths and/or the line spacings are between 1 μm and 50 μm, preferably between 2 μm and 10 μm.

For adaptation to the bending line, it can be necessary that the line widths and/or line spacings of the grid of the reflective layer and/or of the reflective layers and/or the grid of the first volume hologram are not constant, but vary. Preferably, the line widths and/or line spacings vary perpendicularly to the bending line, in particular depending on the bending of the first and/or of the at least one second bent state of the security element.

In particular, the line widths and the line spacings of the grid of the reflective layer and/or of the reflective layers and the layer thickness of the transparent spacing layer are selected such that the effect of the visibility of the first volume hologram is maximized in the first and/or at least one second predefined bent state, for example in the case of a predetermined bending radius, of the security element.

It is advantageous if the layer thickness of the transparent spacing layer substantially corresponds to the grid periods of the line grids of the reflective layers or of the reflective layer. Preferably, the line widths and/or the line spacings are between 1 μm and 50 μm, preferably between 2 μm and 10 μm.

It is advantageous if the spacing layer has a layer thickness between 1 μm and 50 μm, preferably between 2 μm and 10 μm. The lines of the line grids of the two reflective layers preferably run parallel to the bending line of the security element.

It is also possible, instead of a transparent spacing layer with a constant layer thickness, to provide a transparent spacing layer the thickness of which varies. Both a continuous variation of the layer thickness and a stepped, discrete variation of the layer thickness are possible. It is thereby possible to improve the effect of the visibility of the first volume hologram in the first and/or at least one second predefined bent state, and also the effect of the invisibility in the flat state. In particular, the thickness of the spacing layer changes perpendicularly to the bending line. It is advantageous if the spacing layer has the greatest layer thickness in the area of the bending line or along the bending line, and the layer thickness decreases or becomes smaller with distance from the bending line. This means in particular that a greater layer thickness of the spacing layer is provided in the area of small bending angles and a smaller layer thickness of the spacing layer is provided in the area of larger bending angles. The decrease can be both continuous and stepped.

In principle, however, it is further also possible that the reflective layer and/or the reflective layers are formed by a transparent reflective layer, preferably a thin or finely structured metallic layer or a dielectric HRI (high refractive index) or LRI (low reflective index) layer. Such a dielectric reflective layer consists, for example, of a vapor-deposited layer made of a metal oxide or metal sulfide, e.g. titanium oxide etc. with a thickness of 10 nm to 150 nm.

It is further also possible to provide three or more superimposed, structured reflective layers, and two or more transparent spacing layers. This makes possible a better visibility of the volume hologram in the bent state and a greater observation angle range in which the volume hologram is not visible in the flat state.

In a further embodiment, the structured reflective layer is, or the structured reflective layers are, provided not over the whole surface, but only partially over the underlying volume hologram. This makes it possible, in particular, that an area of the volume hologram is also visible in the flat state, with the result that the observer's attention is directed towards the security element. An ever greater part of the volume hologram then becomes visible during bending.

In a further variant, one of the reflective layers is formed as a line grid, whereas the other reflective layer is formed as a gridded layer of extensive grid elements. The formation of Moiré effects through the two layers that are arranged spaced apart and one above the other is utilized here. The geometric shapes of the two reflective layers as well as their dimensions result through mathematical calculation, for example by means of software for the calculation of Moiré effects. As first target value, it is for example predetermined during the calculation that the Moiré effect in the flat state of the security element produces a completely or almost completely non-transparent surface area. The underlying volume hologram is thereby covered in the flat state, and thus not visible or almost not visible. As second target value, it is for example predetermined that in the superimposed reflective layers the Moiré effect in the bent state of the security element produces windows or transparent areas which have specific geometric shapes. In these transparent areas the underlying volume hologram becomes visible.

In a further embodiment example, instead of the structured reflective layer or the structured reflective layers, a structured absorption layer or two spaced-apart absorption layers can also be provided. The above-named embodiments relating to the reflective layer or the reflective layers also apply correspondingly to the absorption layer.

It is also conceivable that only a single grid is used to cover the volume hologram in the flat state. This has the advantage that no register accuracy would be necessary, as in the case of the two or more metal grids. The reflective layer or a metal grid is present here substantially as flanks. The reflective layer is formed, in particular, in the form of flanks. The reflective layer extends not only in the xy-plane, but also in the z-direction. The reflective layer formed in the form of flanks, or the flanks have a similar effect to the louvers in a so-called “privacy filter” for computer screens. The light can pass through the reflective layer substantially perpendicularly, i.e. in the z-direction. As soon as a critical angle g is exceeded, the flanks of the reflective layer almost completely block the light coming from the volume hologram. However, for smaller angles the intensity of the volume hologram is also already reduced as at the critical angle g the light can only pass out of a few points of the volume hologram.

The production of such a reflective layer or such a metal grid results in particular from a louver-like or cup-shaped structure being replicated. The height H of the louvers or cup edges can be between 1 μm and 50 μm, preferably between 2 μm and 20 μm, and particularly preferably between 2 μm and 10 μm. The distance between the louvers or cup edges should preferably be less than or equal to 10×H, better less than 5×H and even better less than 2×H. In a further step, the replicated structure is then vapor-deposited over the whole surface with a reflective layer, preferably with a thin metal layer, for example in a thickness of 20 nm to 30 nm, in particular with aluminum. In a demetalizing step, the reflective layer and/or the metal layer is then removed again in areas. The metal is substantially removed only in the recesses between the louvers or the walls of the “microcups” i.e. only from the “bottom” of the structures. Elements formed substantially in the form of flanks or a reflective layer formed in the form of flanks remain. The demetalizing step can in principle be carried out with all known demetalizing processes.

Advantageously, the at least one third and/or fourth area forms a graphic element, in particular a motif, image, symbol, logo and/or alphanumeric character.

It is further possible that the at least one first area forms a frame around the at least one third and/or fourth area. It is also possible that the at least one first area completely surrounds the at least one third and/or fourth area. Alternatively, it is also possible that the at least one third and/or the fourth area completely surrounds the at least one first and/or second area.

Furthermore, it is expedient that the first and/or the at least one second and/or the third and/or the fourth item of information represents one or more symbols, logos, motifs, images, signs or alphanumeric characters.

Preferably, the first and/or second volume hologram layer has a layer thickness between 3 μm and 100 μm, preferably between 10 μm and 30 μm.

It is further expedient if the first and/or second and/or further volume hologram layers are formed from a photopolymer, in particular from Omni DX 796 (DuPont), silver halide emulsions or dichromatic gelatin.

Preferably, the security element, at least before application to a substrate, for example the security document, comprises a carrier layer, in particular a transparent carrier layer. Preferably, the carrier layer consists of a self-supporting film made of PET (=polyethylene terephthalate), PEN (=polyethylene naphthalate) or BOPP (=biaxially oriented polypropylene) and has a thickness between 5 μm and 250 μm, preferably between 10 μm and 50 μm. After application to the substrate, for example the security document, it is possible to remove the carrier layer.

Alternatively, however, the security element can also be generated directly on the substrate. For example, the volume hologram can be produced directly during the production of polymer banknotes or polymer banknote substrates. In particular, the volume hologram layer and optionally even further layers can be applied directly to the substrate under and/or over the volume hologram layer in each case by known printing processes such as screen printing, gravure printing, offset printing or inkjet printing and the volume hologram layer can be exposed directly on the substrate.

It is further possible that the security element comprises at least one protective varnish layer and/or at least one sealing layer and/or at least one adhesion-promoting layer and/or at least one barrier layer and/or at least one stabilizing layer and/or at least one adhesive layer, in particular comprising acrylates, PVC, polyurethane or polyester.

Using such a security element, a security document can be created which is formed in particular as an identity document, passport document, visa, credit card, banknote, security or the like.

The security element can also lie over a transparent window area of a security document. This can, for example, be a transparent area of a polymer or hybrid banknote or a punched or laser-cut hole in a paper banknote. Here, it is possible, for example via a suitable gridding of the structures in the master, to integrate two volume holograms into the volume hologram layer which show different optical effects when observed from the front and the rear side of the security document in the bent state. These different optical effects can either be to be seen if the bending is kept identical, thus at one time convex and at one time concave. The different effects can, however, also be to be seen if the bending is inverted when the security document is turned over, i.e. the same bend shape—convex or concave—is present when observed from the front and the rear side.

Embodiment examples of the invention are explained below by way of example with the aid of the accompanying figures which are not drawn to scale.

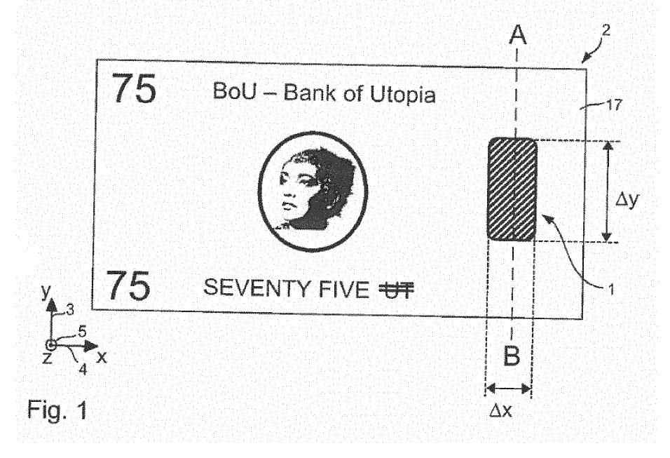

FIG. 1 schematically shows a security document with a security element in top view.

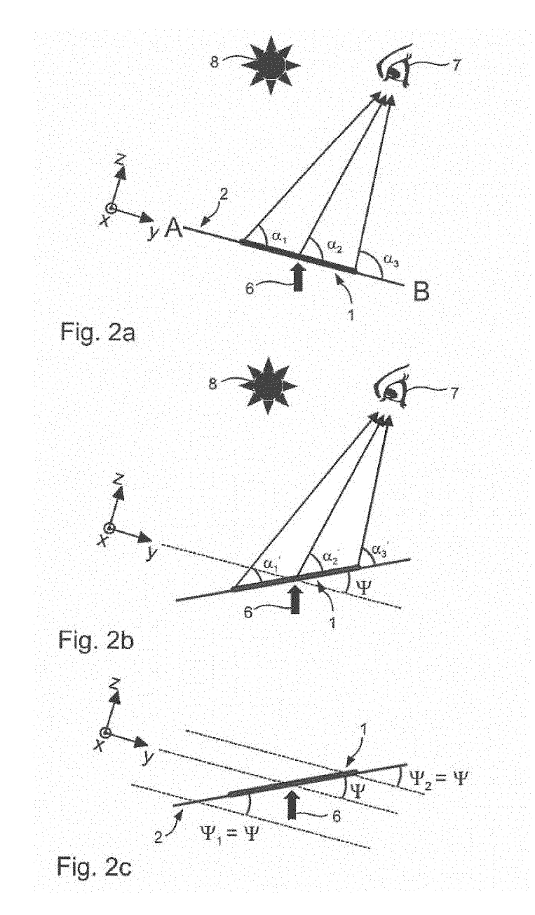

FIG. 2a to FIG. 2c schematically show a tilting of a security element.

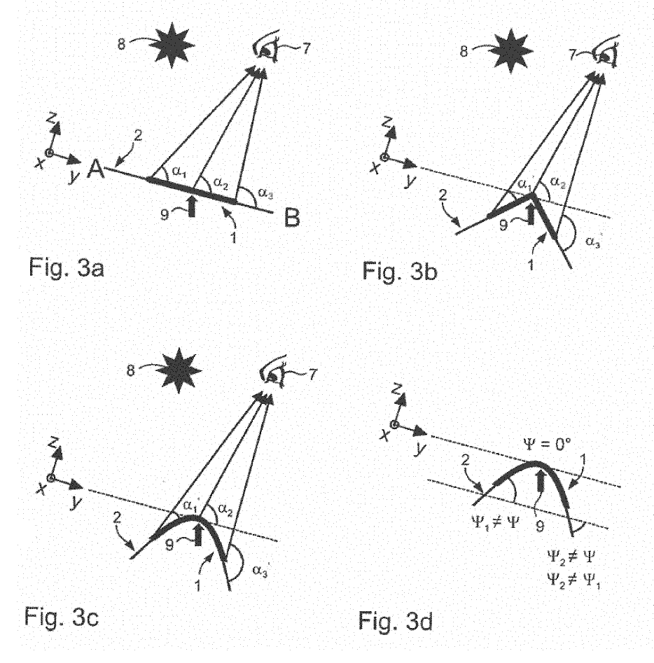

FIG. 3a to FIG. 3d schematically show a bending of a security element.

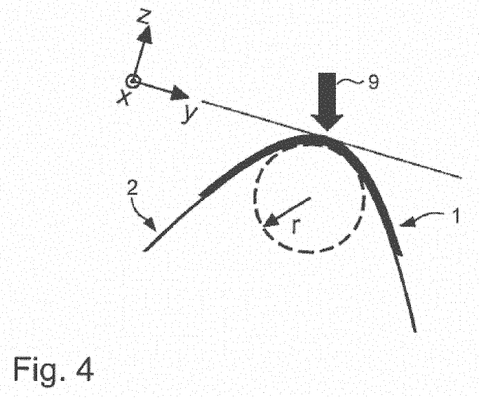

FIG. 4 schematically shows a bent security element.

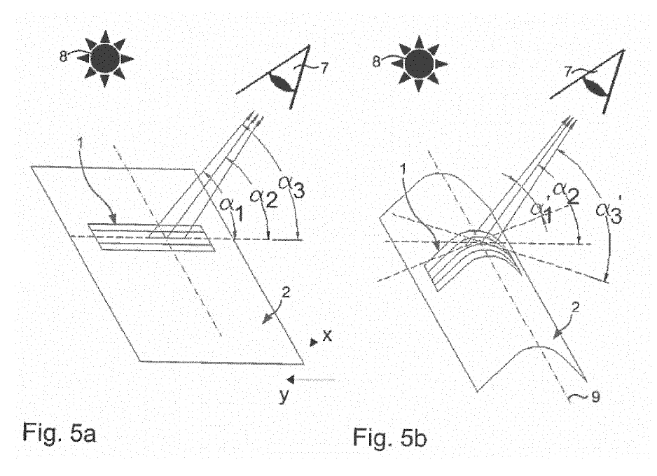

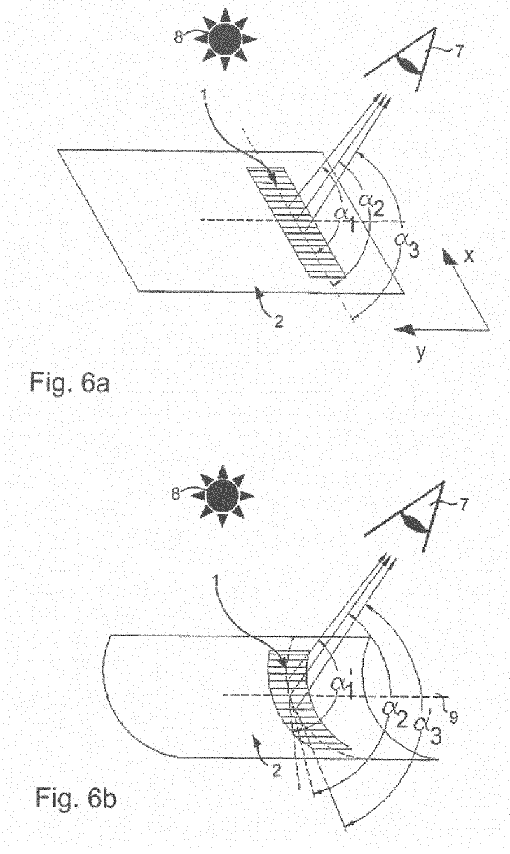

FIGS. 5a, b and FIGS. 6a, b schematically show bending variants of a security element.

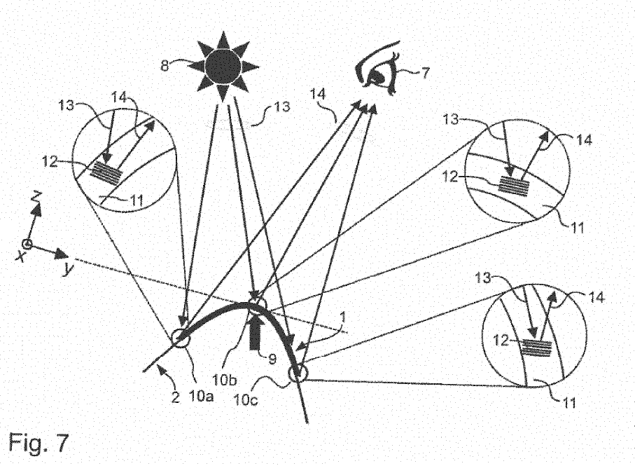

FIG. 7 schematically shows the function of a bent security element.

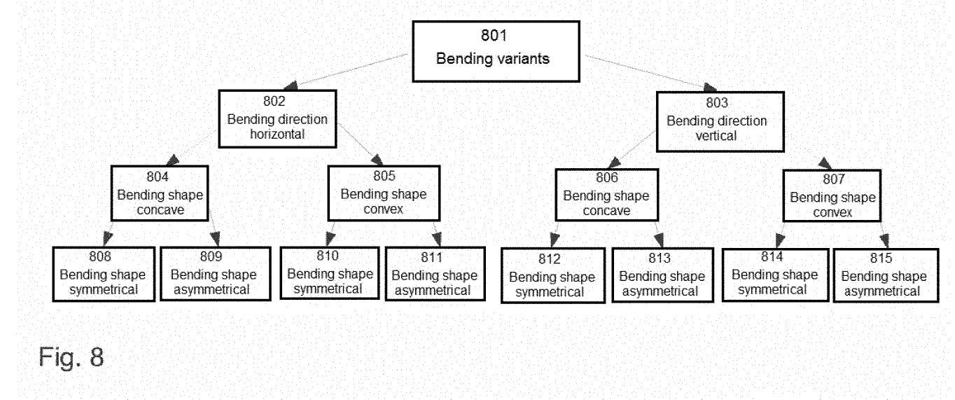

FIG. 8 shows a diagram which specifies bending variants.

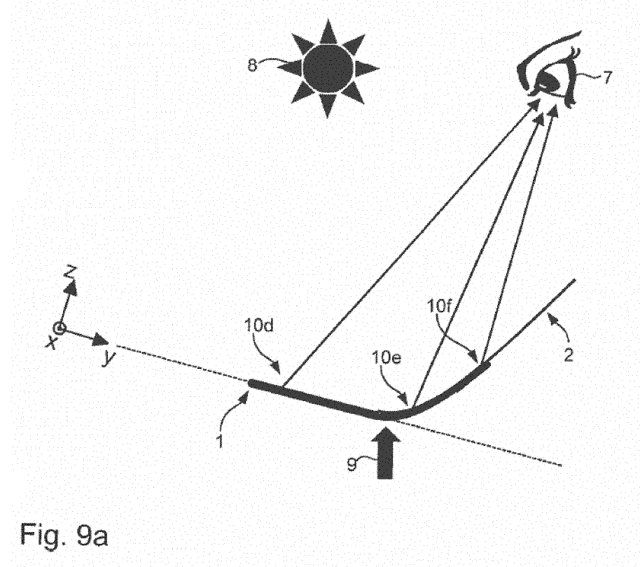

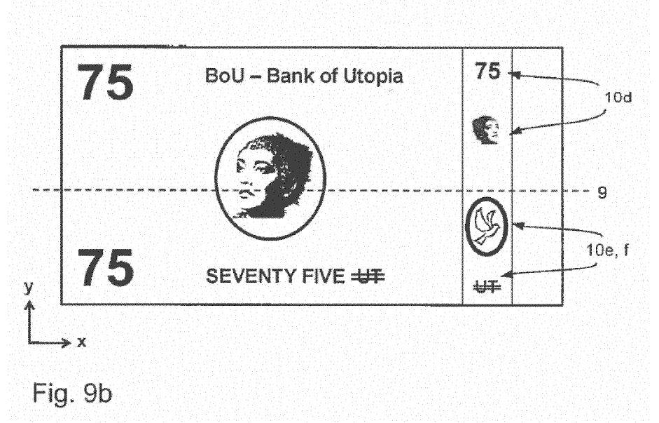

FIG. 9a schematically shows a bent security element.

FIG. 9b shows a strip design represented schematically and simplified, which is designed to be viewed as shown in FIG. 9a.

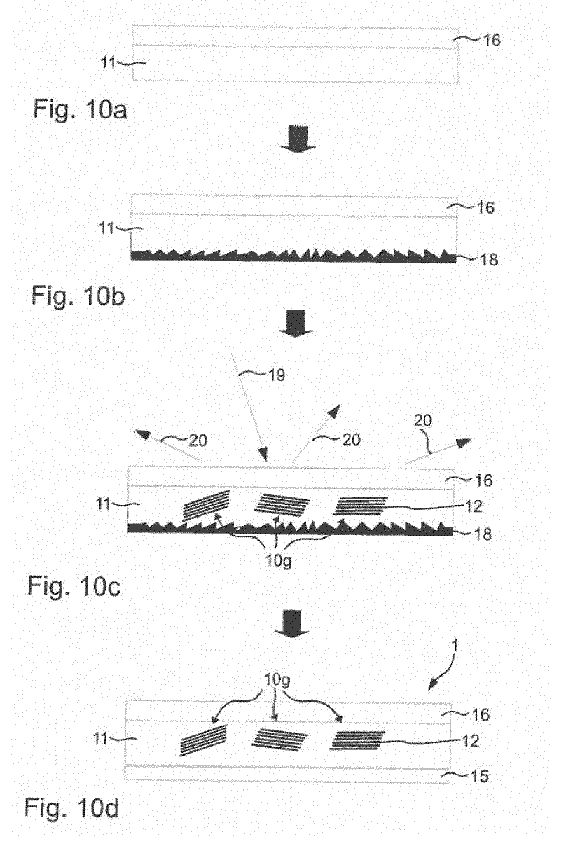

FIG. 10a to FIG. 10d schematically show method steps for producing a security element.

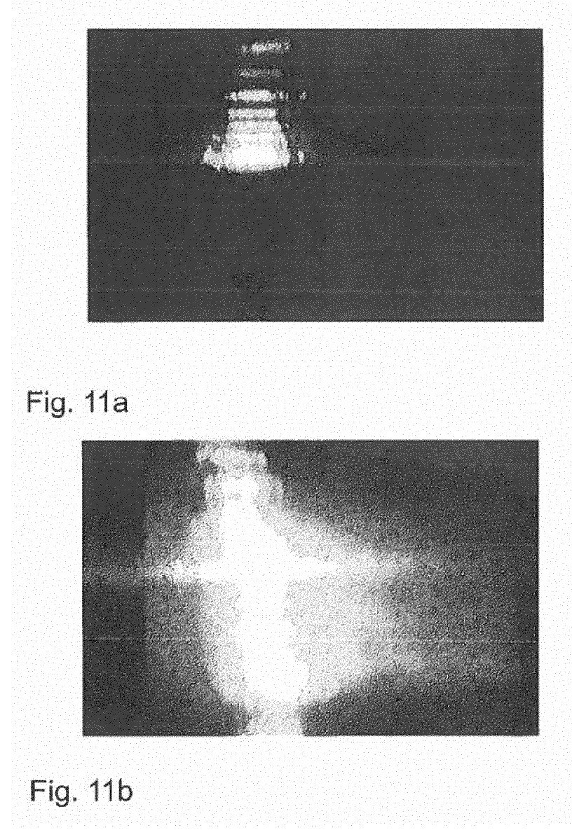

FIG. 11 shows a picture of a security element in an embodiment.

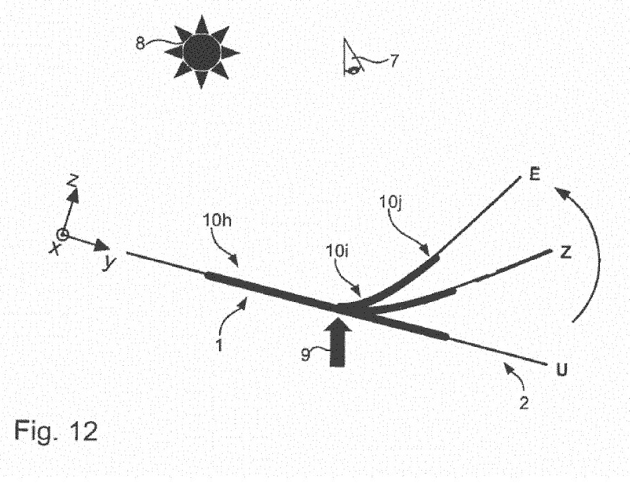

FIG. 12 schematically shows an example of use of a security element.

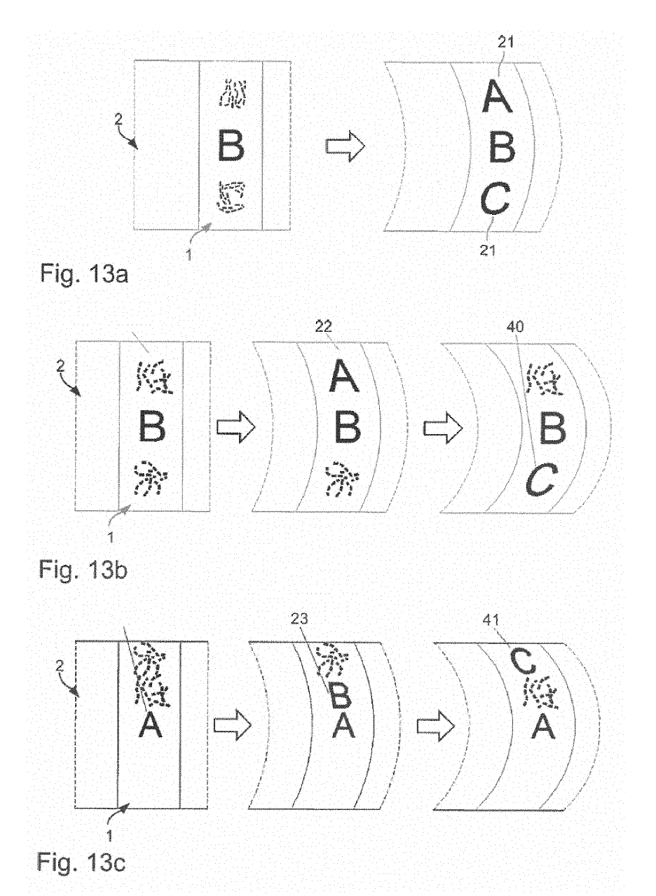

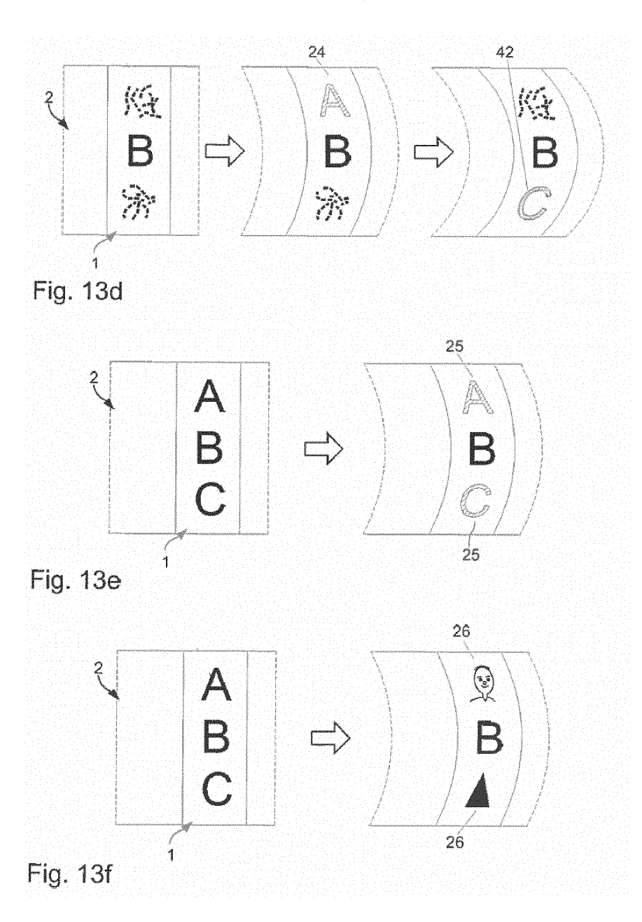

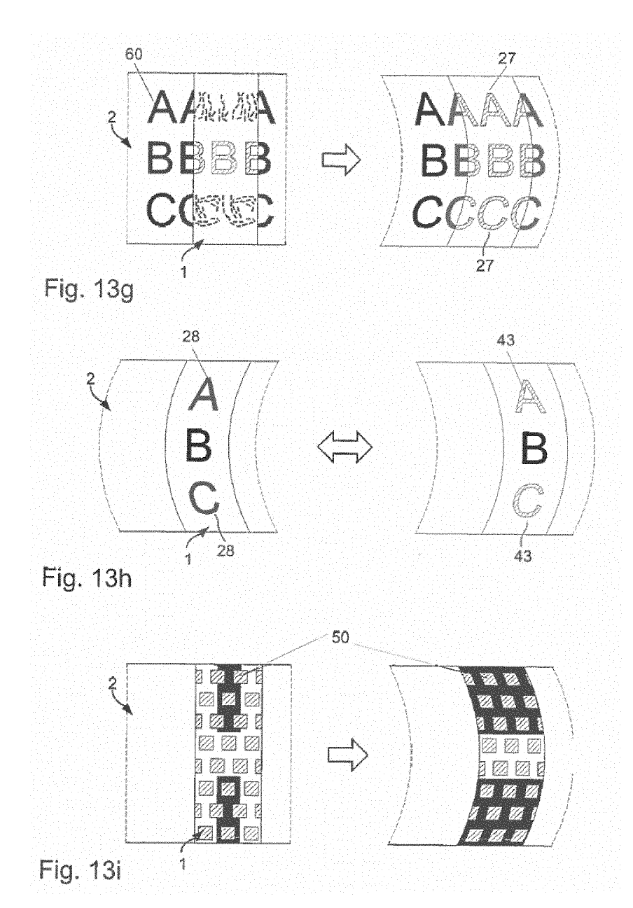

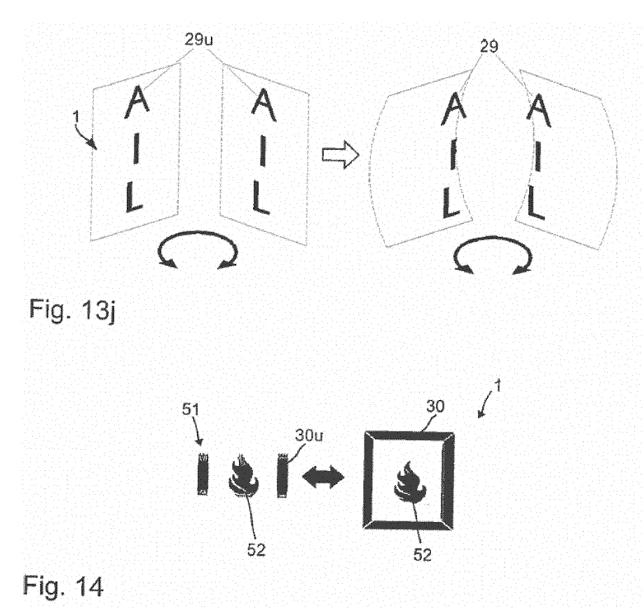

FIG. 13a to FIG. 13j schematically show examples of use of security elements.

FIG. 14 schematically shows an example of use of a security element.

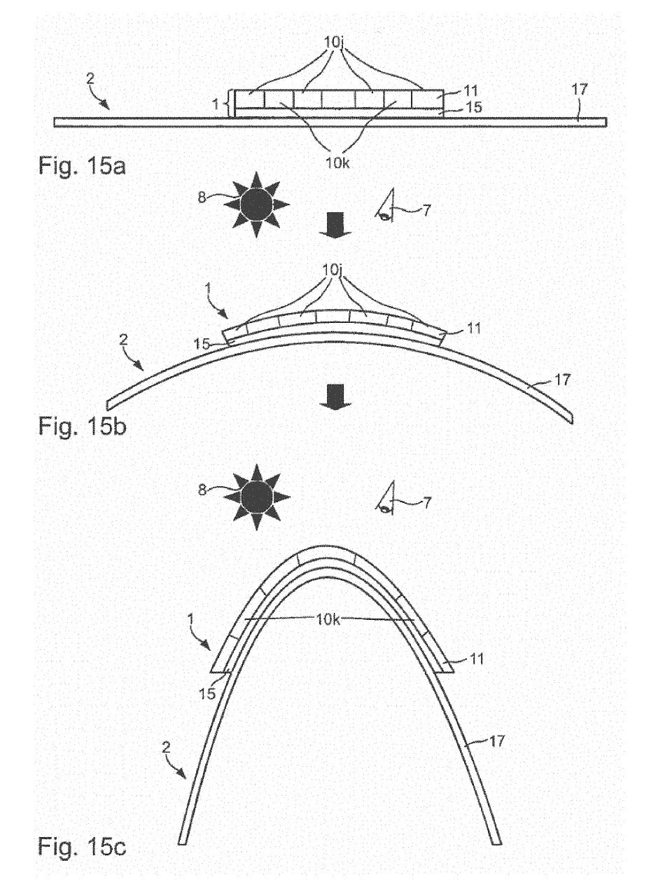

FIG. 15a to FIG. 15c schematically show a bent security document with a security element.

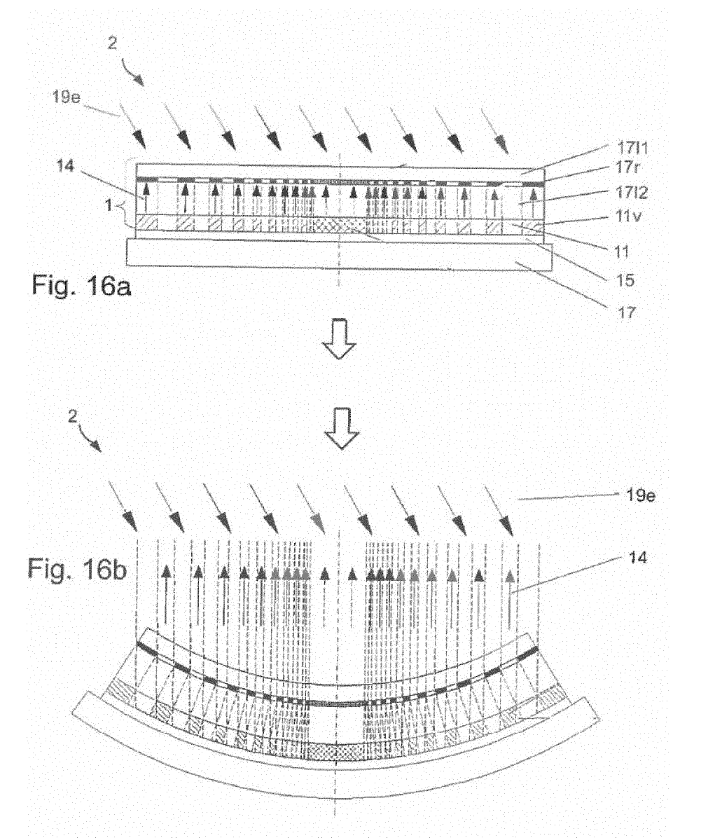

FIGS. 16a, b schematically show a flat and, respectively, bent security document with a security element.

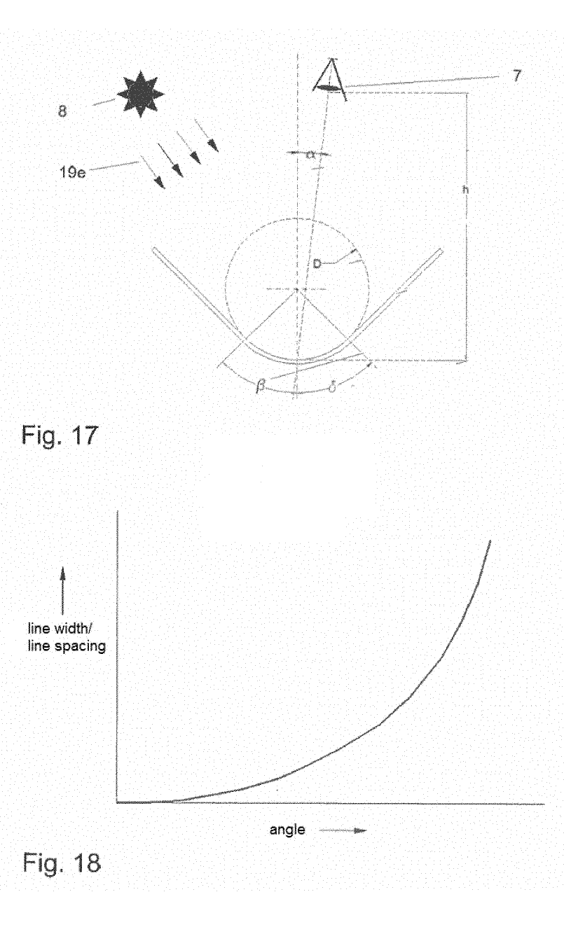

FIG. 17 shows a schematic representation of parameters for determining line widths and line spacings of the volume hologram or the reflective layer.

FIG. 18 shows the dependence of the determined line widths and line spacings on the angle of curvature.

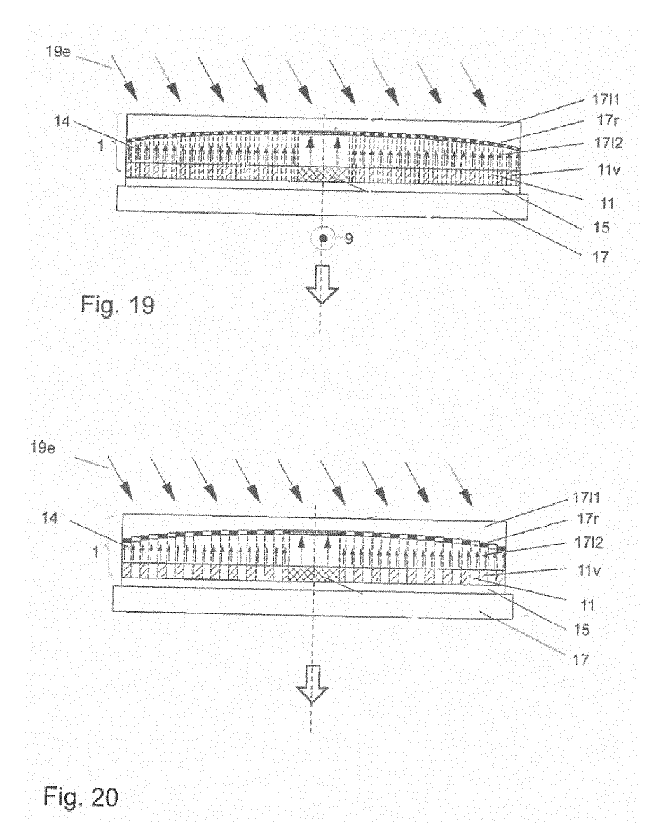

FIGS. 19 and 20 schematically show in each case a flat security document with a security element with a spacing layer with variable layer thickness.

FIG. 21 schematically shows in each case a flat security document with a security element.

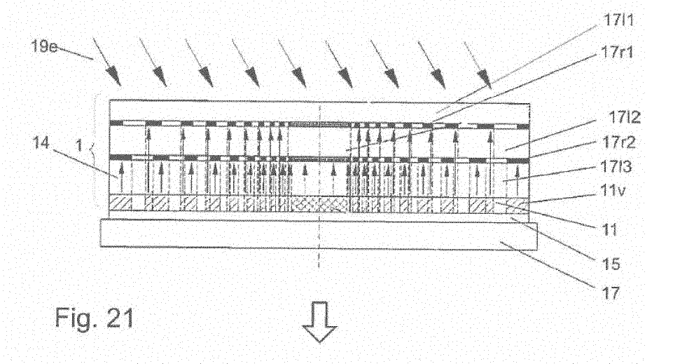

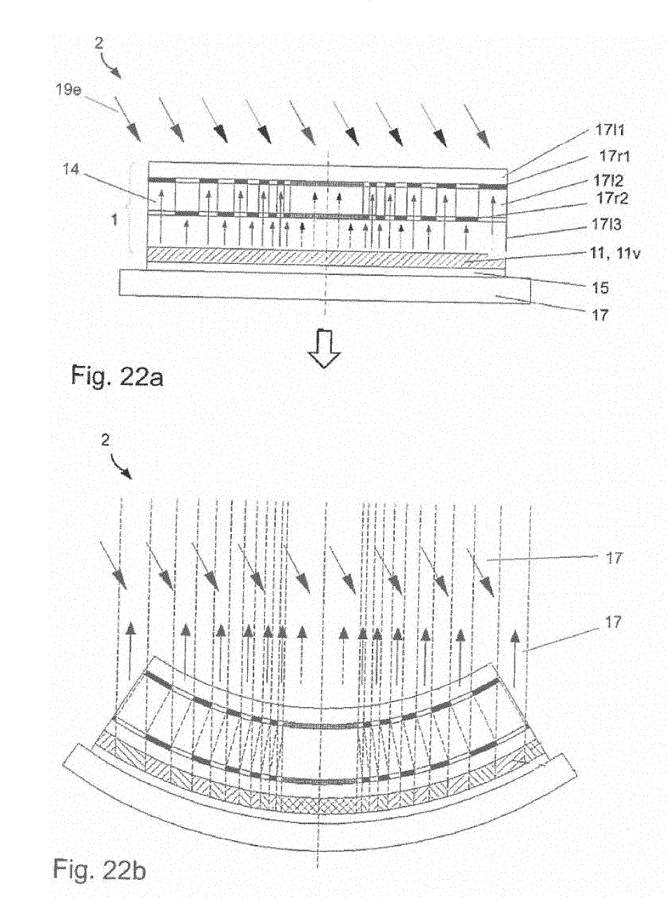

FIGS. 22a, b schematically show a flat and, respectively, bent security document with a security element.

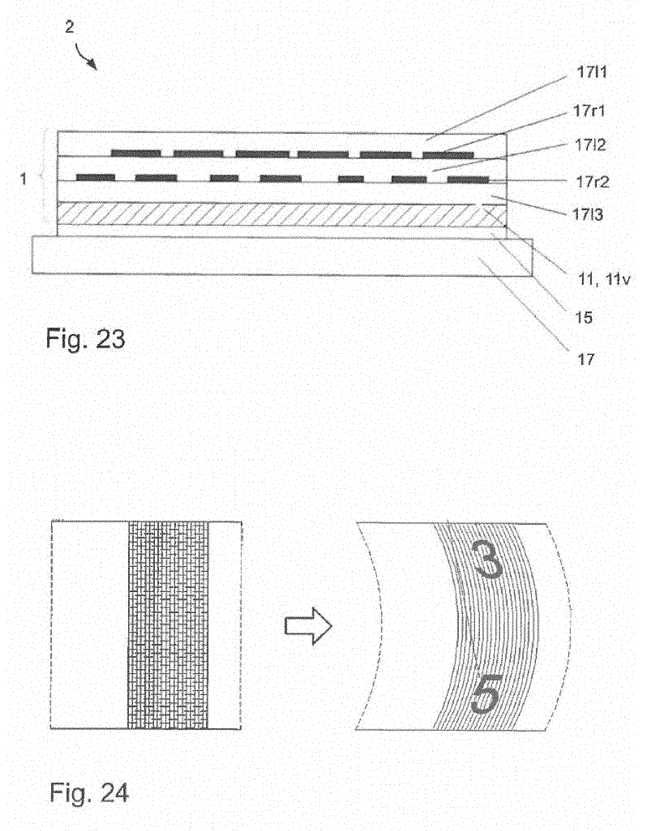

FIG. 23 schematically shows a flat security document with a security element.

FIG. 24 schematically an example of use of a security element.

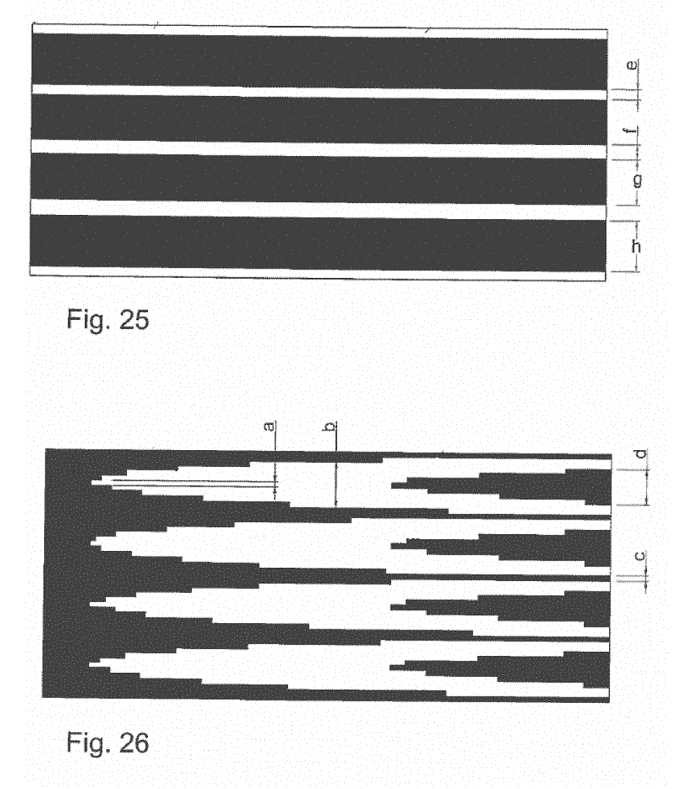

FIG. 25 shows a top view of a detail of a layer formed as a line grid.

FIG. 26 shows a top view of a detail of a gridded layer made of extensive grid elements.

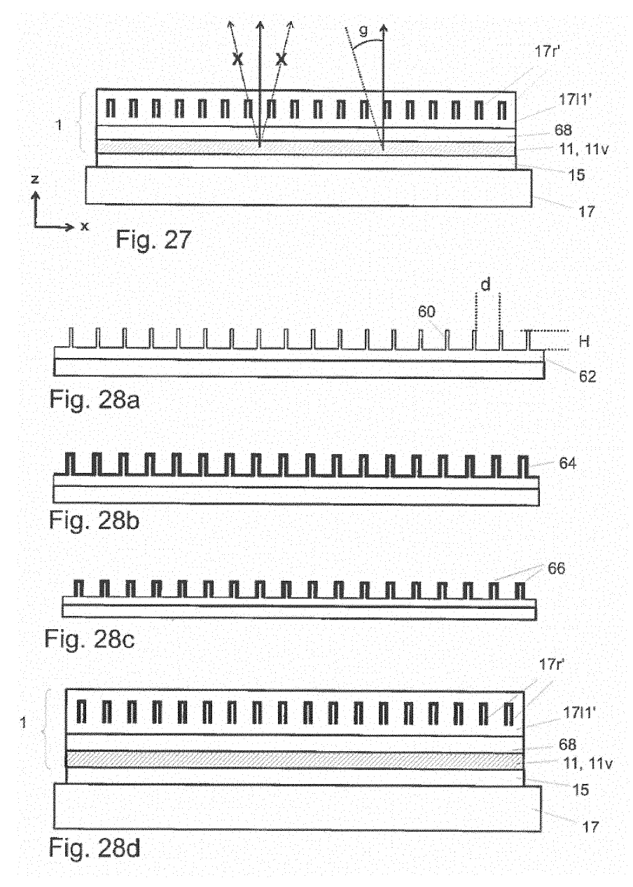

FIG. 27 schematically shows a flat security document with a security element.

FIGS. 28a to 28d show a possible production method for the security element shown in FIG. 27.

FIG. 1 shows the top view of a security document 2 with a security element 1. In the example represented in FIG. 1 the security document 2 is a banknote. However, it is also possible that the security document 2 is an identity document, passport document, visa, credit card, security or the like.

The security document 2 consists of a flexible, elastic or non-elastic substrate 17, on which the security element 1 is arranged. The substrate 17 is preferably a substrate made of paper material which is provided with printing, and into which further security features, such as for example water marks or security threads, are introduced and/or to which these are applied. In particular, the substrate 17 or the security document 2 can be a paper banknote or a paper visa. However, it is also possible that the substrate 17 is a plastic film or a laminate consisting of one or more paper and/or plastic layers. Examples of plastic films for polymer banknotes, in particular made of BOPP are e.g. the substrate Guardian® from Innovia or Safeguard® from De La Rue or also Tyvek® from Dupont. Examples of laminates made of paper and plastic layers, also called hybrid substrates, are for example Durasafe® from Landquart or “Hybrid” from Giesecke & Devrient. The thickness of the carrier substrate 17, in particular if it is a banknote, is between 6 μm and 150 μm, preferably between 15 μm and 50 μm.

The security document 2, as shown in FIG. 1, lies in the xy-plane and is thus plane or flat in the state shown in FIG. 1. The security element 1, as shown in FIG. 1, has the dimensions Δx and Δy.

Preferably, the security element 1 is applied to the security document 2 by means of stamping, in particular by means of cold or hot stamping. It has proved successful here if the security element 1 is provided on a transfer film, with the result that an application of the security element 1 to a security document 2 can be effected by means of stamping. Such a transfer film has at least one security element 1, wherein the at least one security element 1 is arranged detachable from a carrier layer in the form of a carrier film of the transfer film. Starting from the carrier layer of the transfer film, a detachment layer is usually present here, in order to be able to detach the security element 1 from the carrier layer after stamping. The security element 1 can be fixed to the security document 2 by means of an adhesive layer, in particular made of a cold or hot-melt adhesive.

Alternatively, the security element can also be provided on a laminating film, wherein the application is effected by lamination and the carrier layer remains on the security element.

It is also conceivable to produce the security element 1 directly on the security document 2. In particular, the volume hologram layer 11 and optionally even further layers can be applied directly to the substrate 17 under and/or over the volume hologram layer 11 in each case by known printing processes such as screen printing, gravure printing, offset printing or inkjet printing and the volume hologram layer can be exposed directly on the substrate 17.

The security element 1 fixed on the security document 2 is applied to the security document 2 such that it adapts to changes in shape and/or geometry of the security document 2. In particular, the security element 1 is bendable, with the result that the shape of the security element 1 is changed or can be changed by the application of force. If, for example, the security document 2 shown in FIG. 1 is bent in the center of the security document 2 symmetrically around the x-axis, the applied security element 1 undergoes substantially the same change in shape as the security document 2 in the area of the security element 1.

In the following, the difference between a tilting and a bending of the security element 1 is first illustrated with reference to FIG. 2a to FIG. 2c and FIG. 3a to FIG. 3d. In the following, for the sake of simplicity, only a tilting or bending of the security element 1 is discussed and not, as usually represented in the figures, a tilting or bending of the security document 2 together with the security element 1 arranged thereon.

FIG. 2a to FIG. 2c schematically show a tilting of a security element 1 around the x-axis. By tilting is meant here that the security element 1 is brought into an inclined position, wherein the shape of the security element 1 does not change. The security element 1 is therefore rigid during a tilting. FIG. 2a shows the security document 2 along the section A-B shown in FIG. 1, in a side view. The security document 2 and the security element 1 applied thereto are situated in the xy-plane in FIG. 2a and illuminated by an illumination device 8, for example the sun. As shown in FIG. 2a, light from the security element 1 here reaches the eye of an observer 7 at the different observation angles α₁, α₂ and α₃. If the security element 1, as shown in FIG. 2b, is tilted out of the xy-plane around the tilting point 6 by the angle Ψ, the observation angles α₁, α₂ and α₃ at which the light from the security element 1 reaches the eye of the observer 7 change such that the angles α₁′, α₂′ and α₃′ in the tilted state of the security element 1 are all smaller. During a tilting around the horizontal axis, which here corresponds to the x-axis, away from the observer, as shown in FIG. 2b, all the observation angles thus become smaller in comparison with the original untilted state in FIG. 2a. Likewise, if the security element 1 tilts around the horizontal x-axis towards the observer, all the observation angles at which light from the security element 1 reaches the eye of the observer 7 increase. The same applies to a tilting around the vertical y-axis. Thus, during a tilting both around the horizontal axis and around the vertical axis of the security element 1, all the observation angles change in the same direction, independently of which side of the tilting point 6 the light comes from. As shown in FIG. 2c, in the tilted state the entire security document and thus also all the areas of the security element 1 have the same angle Ψ with respect to the y-axis.

FIG. 3a to FIG. 3d schematically show a bending of a security element 1. By “bending” is meant here the deformation of an object in a specific manner by exertion of a force. By “ bending” of a security element 1 is therefore meant the exertion of force on the security element 1, wherein the shape of the security element 1 is changed or can be changed by the application of force. A bent security element 1 thus has a changed geometry in comparison with the unbent security element 1. Further, by “bending” is also meant a kinking, with the result that a bent security element 1 can have one or more kink points or kink lines, at which the security element 1 is sharply or abruptly bent. FIG. 3a again shows the security document 2 situated in the xy-plane, along the section A-B shown in FIG. 1, in a side view as in FIG. 2a, wherein light from the security element 1 arranged on the security document 2 here reaches the eye of an observer 7 at the different observation angles α₁, α₂ and α₃. If the security element 1, as shown in FIG. 3b, is bent or kinked around the bending point 9 away from the observer 7, the observation angles α₁′ and α₃′ at which light from the security element 1 reaches the eye of the observer 7 change in a different way on different sides of the bending point 9. Thus, for example, the observation angle α₁′ becomes smaller, whereas the observation angle α₃′ becomes greater in comparison with the unbent state of the security element 1 in FIG. 3a. On the other hand, the observation angle α₂ in the bending point 9 remains the same.

On the other hand, if the security element 1 is bent towards the observer 7, with the result that a concave shape of the security element 1 results, the observation angles change inversely. FIG. 3b shows the extreme case of bending, namely kinking. FIG. 3c also shows the changed observation angles α₁′ and α₃′ in a bent state of the security element 1, wherein the bent state of FIG. 3c can be approximately described by a parabola. Here too, the observation angles α₁′ and α₃′ change on different sides of the bending point 9, similarly to what is stated above. As shown in FIG. 3d, in particular in comparison with a tilted security element, as shown in FIG. 2c, in the case of a bent security element 1 the angles Ψ with respect to the y-axis are different in the area of the security element 1. Thus the angles Ψ₁ and Ψ₂ differ on both sides of the bending point 9, whereas the angle Ψ, as shown in FIG. 2c, is the same on both sides of the tilting point 6. Further, the angle Ψ, taken at the bending point 9, as shown in FIG. 3d, differs from the angles Ψ₁ and Ψ₂. As shown in FIG. 3d, the angle Ψ is equal to zero at the bending point 9. The bending point 9 is here situated in the area of the security element 1, as shown by FIG. 3a to FIG. 3d.

As shown by FIG. 2a to FIG. 2c and FIG. 3a to FIG. 3d and the above statements, the geometric relationships of the illumination and observation angles differ from each other in a tilted and in a bent state of the security element 1.

It is further possible to describe the bent state of the security element 1, described above in particular via geometric characteristics, via the mathematical Laplace function. Thus it is possible that, if the Laplace operator Δ is applied to a surface of the security element 1 described by a function F(x,y), a predefined limit value G is exceeded in the bent state of the security element 1 and is not exceeded in the unbent state, wherein the function F(x,y) describes the distance from the surface of the security element 1 to a two-dimensional reference surface area spanned by the coordinate axes x and y. For example, for a security element 1 in an unbent state ΔF(x,y)<G applies and for a security element 1 in the bent state ΔF(x,y)>G applies. Preferably, the value of ΔF(x,y) is compared with the predefined limit value G here.

FIG. 4 schematically shows the representation of a bent security element 1. As shown in FIG. 4, the bent state of a security element 1 can be described by the bending radius r. By “bending radius” is meant here the radius r of the largest circle which lies tangential to the bending point 9 and at the same time has no points of intersection with the security element 1. Preferably, in the bent state of the security element 1 the bending radius is between 1 mm and 100 mm, preferably between 2 mm and 50 mm, further preferably between 4 mm and 30 mm, and even further preferably between 10 mm and 25 mm.

FIGS. 5a, b and FIGS. 6a, b schematically show bending variants of a security element 1. FIGS. 5a, b show the bending of the security element 1 around the horizontal axis which here corresponds to a line parallel to the x-axis. FIG. 5a here shows a security document 2 with a security element 1 arranged thereon in the unbent state. With respect to the embodiment of the security document 2, reference is made here to the above statements. As already explained, light from the security element 1 here reaches the eye of an observer 7 at the different observation angles α₁, α₂ and α₃. FIG. 5b now shows the security document 2, wherein the security document 2 and the security element 1 arranged thereon are bent around the horizontal axis. The security element 1 and the security document 2 are bent around the bending line 9, as shown in FIG. 5b. As already explained, in the bent state of the security element 1 the observation angles α₁′ and α₃′ change differently on different sides of the bending line 9. On the other hand, the observation angle α₂ around the bending line 9 remains the same.

FIGS. 6a, b show the bending of the security element 1 around the vertical axis, which here corresponds to a line parallel to the y-axis. FIG. 6a here shows a security document 2 with a security element 1 arranged thereon in the unbent state. With respect to the design of the security document 2, reference is made here to the above statements. As already explained, light from the security element 1 here reaches the eye of an observer 7 at the different observation angles α₁, α₂ and α₃. FIG. 6b now shows the security document 2, wherein the security document 2 and the security element 1 arranged thereon are bent around the vertical axis. The security element 1 and the security document 2 are bent around the bending line 9, as shown in FIG. 6b. As already explained, in the bent state of the security element 1 the observation angles α₁′ and α₃′ change differently on different sides of the bending line 9 here, whereas the observation angle α₂ remains the same around the bending line 9.

FIG. 7 schematically shows the function of a bent security element 1 with a volume hologram layer 11, into which a volume hologram 11v is introduced. As shown in FIG. 7, the volume hologram 11v is formed such that an item of information is visible for an observer 7 in an observation situation in the bent state of the security element 1 and is not visible in the same observation situation in the unbent state of the security element 1. The security element in FIG. 7 has a length of 30 mm in the direction of the coordinate axis y. It is also possible that, in the direction of the coordinate axis x or y around which the security element 1 is bent in the bent state, the security element 1 has a length of at least 5 mm, preferably of at least 10 mm, further preferably of at least 20 mm, even further preferably of at least 50 mm.

The volume hologram layer 11 is preferably a layer made of a photopolymer, in particular of Omni DX 796 from DuPont, Wilmington, USA. It is further also possible that the volume hologram layer 11 is formed from a silver halide emulsion or dichromatic gelatin. The layer thickness of the volume hologram layer 11 is preferably between 3 μm and 100 μm, in particular between 10 μm and 30 μm.

A volume hologram 11v is introduced into the volume hologram layer 11. The volume hologram 11v has a periodic modulation of the refractive index which, in FIG. 7, is indicated by the dark lines arranged alternating in the enlarged representations of the security element 1. In the enlarged schematic representations, light refraction at the boundary surface between volume hologram layer 11 and adjoining varnish layer or air has been disregarded. Through the refractive index variations, in the volume hologram layer 11 a plurality of nodes are formed, which bring about a diffraction of the incident light 13 and thus form an optically active element. In the individual zones 10a, 10b and 10c, the nodes, as shown in FIG. 7, are arranged in planes running substantially parallel to each other. The nodes have a refractive index n′ which deviates from a refractive index n of the remaining volume hologram layer 11 by δ: n′=n+δ. Thus, the volume hologram layer 11 has a location-dependent refractive index n′, which describes a three-dimensional refractive index pattern stored in the volume hologram layer 11. These planes formed by refractive index variations are also referred to as Bragg planes 12. Typically, the difference δ in the refractive index is between 0.005 and 0.1, preferably between 0.01 and 0.05.

This three-dimensional refractive index pattern can be produced by a holographic interference arrangement, for example by a structure in which a coherent light beam, in particular a laser source, is deflected on a master with a surface structure arranged on the volume hologram layer 11. The light beam striking the volume hologram layer 11 in order to introduce the volume hologram 11v is first refracted at the volume hologram layer 11 and then deflected at the master by diffraction at the surface structure. The deflected beams represent the object wave which interferes with the reference wave incorporated by the incident light beam and triggers a local polymerization in the volume hologram layer 11. As a result of the polymerization, the refractive index of the volume hologram layer 11 is changed locally. The refractive index variations are localized in the Bragg planes 12. FIG. 10 shows this process by way of example.

As shown in FIG. 7, the Bragg planes 12 in the zones 10a, 10b and 10c are here aligned such that in the bent state of the security element 1 they diffract and/or reflect incident light 13 such that the light 14 diffracted and/or reflected by the Bragg planes 12 reaches the eye of the observer, with the result that an item of information is perceptible for the observer 7. With respect to the bent state of the security element 1, reference is made here to the above statements. The volume hologram introduced into the volume hologram layer 11 is thus designed for a predetermined bent state of the security element. For this, the volume hologram has the zones 10a, 10b and 10c, wherein the zones 10a, 10b and 10c provide an item of information for the observer 7 in an observation situation in the predefined bent state of the security element 1.

As shown in FIG. 7, in the predefined bent state of the security element 1 the angles enclosed between the normals to the Bragg planes 12 and the direction of the incident light 13 in the zones 10a, 10b and 10c are substantially identical to the angles enclosed between the normals to the Bragg planes 12 and the direction of the light 14 reflected and/or diffracted by the Bragg planes. Preferably, the alignments of the Bragg planes 12 in the zones 10a, 10b and 10c are thus substantially identical to each other in the predefined bent state of the security element 1.

Through the parameter: distance between the Bragg planes in the zones 10a, 10b and 10c, for example, the color of the light 14 diffracted and/or reflected by the respective zones 10a, 10b and 10c for the observer 7 can also be determined. It is hereby made possible, for example, that the light diffracted and/or reflected by the zones 10a, 10b and 10c appears in the same color or in different colors for the observer 7. For different colors, it is advantageous if the distance between the Bragg planes differs by more than 2 nm, preferably more than 10 nm, even further preferably by more than 20 nm. If the distance between the Bragg planes in the zone 10a is, for example, approximately 260 nm, the light diffracted and/or reflected by the zone 10a appears green to the observer. On the other hand, in the case of a distance between the Bragg planes in the zone 10b of, for example, approximately 320 nm, the light diffracted and/or reflected by the zone 10b appears red to the observer.

The zones 10a, 10b and 10c can produce a common item of information for the observer, for example an image, wherein each zone 10a, 10b and 10c produces a part of the image. However, it is also possible that the zones 10a, 10b and 10c each produce an individual item of information for the observer. For example, the zone 10a can produce a letter for the observer 7 in one color and the zone 10b can produce a further letter for the observer 7 in a further color.

In the unbent state of the security element 1 the zones 10a, 10b and 10c shown in FIG. 7 have a length of 200 μm in the direction of one of the coordinate axis y. Preferably, in the unbent state of the security element 1 the zones 10a, 10b and 10c have a length of at least 10 μm, preferably 500 μm, even further preferably 2000 μm in the direction of one of the coordinate axes x and/or y. In particular, the zones 10a, 10b and 10c can also be, or be present, virtually continuous and not discretely distributed.

FIG. 8 shows a diagram which specifies bending variants. As already explained, the volume hologram is designed for one or more bent states of the security element. It is thus possible, for example, that, as shown in FIG. 7, an item of information is visible for the observer 7 only in the case of a state of the security element 1 bent away from the observer 7.

FIG. 8 now shows a possible classification of bending variants of a security element. The volume hologram is here generated for a predetermined bending variant 801, with the result that the item of information becomes visible for the observer only during bending of the security element into this predetermined bending variant. As shown in FIG. 8, the classification of the bent state of the security element can only be differentiated according to a horizontal bending direction 802 and/or a vertical bending direction 803. Advantageously, the security element is thus bent around the x-axis and/or the y-axis in the predefined bent state. By a bending around the x-axis and/or y-axis is also meant a bending relative to a line parallel to one of these axes. A further classification of the bent state of the security element can be differentiated according to whether the security element is bent towards the observer in the predefined bent state, in particular whether the security element has a concave shape 804, 806 in the predefined bent state and/or whether the security element is bent away from the observer, in particular whether the security element has a convex shape 805, 807, in the predefined bent state. Furthermore, the bent state of the security element, as shown in FIG. 8, can be differentiated according to a symmetrical bending shape (with respect to a bending line) 808, 810, 812, 814 or an asymmetrical bending shape (with respect to the bending line) 809, 811, 813, 815.

The individual bending variants 801 shown in FIG. 8 can be further specified here. Thus, the bending variants 801 can, for example, as stated above, be further specified by means of the bending radius, the above-described geometric characteristics of the bent state of the security element, or by means of the mathematical Laplace function. The predetermined bending variant now determines the alignment of the Bragg planes in the zones such that the desired item of information is visible for the observer in the predefined bent state. Thus, for example, it can first be determined that in the case 805 of FIG. 8 the item of information is to be visible for the observer, i.e. the item of information is to be visible in the case of a horizontal bending direction away from the observer. The exact angular sizes for this case can, for example, be determined via the geometric characteristics in this case, as shown in FIG. 3d. The alignment of the individual zones, which then correspondingly generate the item of information for the observer in this bent state, can then be established with reference to the angles Ψ, Ψ₁ and Ψ₂. Zones which are not correspondingly aligned are not visible, or scarcely visible, in the predefined bent state, or do not contribute to the item of information for the observer. However, it is possible that the Bragg planes in these zones are aligned such that they become visible in further predefined bent states. For example, in the case of a further bending of the security element or in the case of a change from a concavely bent security element to a convexly bent security element, a further item of information can be produced by further zones or the present item of information can be complemented. As already explained, the Bragg planes are here aligned in the further zones such that the further item of information is visible for the observer only in the further predefined bent state of the security element. It is further also possible that the distance between the Bragg planes in the zones and/or the further zones differs, with the result that different color impressions can be produced for the observer.

FIG. 8 represents only one possible division, further divisions are possible. The divisions can thus determine the predetermined bent state of the security element in which, as described above, an item of information is visible for an observer in an observation situation and is not visible in the observation situation in the unbent state of the security element or vice versa.

FIG. 9a schematically shows a bent security element 1. The security element 1 is here, as explained above, applied to a security document 2, for example a banknote. The security element 1 comprises a volume hologram layer, into which a volume hologram is introduced. The volume hologram is here designed such that it produces an item of information for the observer 7 in the observation situation shown in FIG. 9a in the predefined bent state of the security element 1 shown in FIG. 9a. The bent state shown in FIG. 9a is characterized in that the security element 1 to the left of the bending point 9 is not bent, because it is lying on a level base, for example a tabletop, and the security element 1 to the right of the bending point 9 is bent towards the observer 7. The bent state shown in FIG. 9a thus corresponds to the bending variant 809 of FIG. 8. The shape of the security element 1 in the state bent in this way can further be described approximately by a half-parabola. The volume hologram here has the zones 10d, 10e and 10f, wherein the Bragg planes in the zones 10d, 10e and 10f are aligned such that an item of information is visible for the observer 7 in the observation situation shown in FIG. 9a and in the bent state shown in FIG. 9a. In the unbent state and in the case of the same observation situation only the light reflected and/or diffracted by the zone 10d is recognizable for the observer 7, whereas the light reflected and/or diffracted by the zones 10e and 10f is not directed to the eye of the observer.

FIG. 9b shows an example of a strip design, represented schematically and simplified, which is designed for an observation as shown in FIG. 9a. The figure “75” and the portrait, e.g. formed in particular as a Fresnel-like freeform surface, contain zones 10d and lie in the flat area, i.e. above the bending point 9. The frame and the image of the dove as well as the denomination, here [symbol] , lie below the bending point and thus in the bent area of the security element 1. These design elements contain zones 10e and 10f and light up completely only in the bent state or show the desired item of information only in the bent state. For example, the dove can be a hologram which has been generated on a master exposed curved. In the flat state only a washed-out, unrecognizable surface is to be seen here. The dove then appears in the bent state. At the same time, the frame lights up completely and the denomination [symbol] appears.

FIG. 10a to FIG. 10d schematically show method steps for producing a security element 1. FIG. 10a shows a transparent carrier layer 16 in the form of a self-supporting carrier film, for example made of PET (=polyethylene terephthalate), PEN (=polyethylene naphthalate) or BOPP (=biaxially oriented polypropylene) with a thickness between 10 μm and 50 μm. The layer thickness of the transparent carrier layer 16 in FIG. 10a is, for example, 15 μm. A volume hologram layer 11 is applied to the transparent carrier layer 16. The volume hologram layer 11 is preferably applied to the carrier layer 16 by printing, casting, e.g. slot casting, or using a doctor blade. The volume hologram layer 11 consists, for example, of Omni DX 796 from DuPont, Wilmington, USA, and has a layer thickness of between 3 μm and 100 μm. The layer thickness of the volume hologram layer 11 in FIG. 10a is, for example, 25 μm.

It is further possible that a detachment layer is applied to the carrier layer 16 first, before the volume hologram layer 11 is printed on, cast or applied using a doctor blade. The detachment layer can be provided in order to facilitate the subsequent detachment of the carrier layer from the volume hologram layer.

It is further possible that the security element 1 comprises at least one protective varnish layer and/or at least one sealing layer and/or at least one adhesion-promoting layer and/or at least one barrier layer and/or at least one stabilizing layer and/or at least one adhesive layer, in particular comprising acrylates, PVC, polyurethane or polyester.

As shown in FIG. 10b, a preferably opaque master 18 with a surface structure is arranged on the volume hologram layer 11, underneath the volume hologram layer 11. The volume hologram layer 11 can here be brought into contact with the side of the master 18 having the surface structure directly or with the interposition of a transparent optical medium.

The master 18 is here designed such that the volume hologram to be inscribed in the volume hologram layer 11 by means of the master 18 makes an item of information visible for an observer in an observation situation in a predefined bent state of the security element 1 and makes it not visible in the first observation situation in the unbent state of the security element or vice versa.

Such a master 18 can, for example, be generated starting from a bent intermediate master, wherein the bending of the bent intermediate master corresponds to the bending of the predefined bent state of the security element 1. Thus an intermediate master is first generated by means of holographic exposure, wherein the intermediate master is present in the predefined bent state. Starting from this bent intermediate master, a flat master 18 with the surface structure is then created, which is arranged on the volume hologram layer 11.

The flat master 18 can also have an in particular Fresnel-like cylindrical lens structure as surface structure, wherein the curvature of the Fresnel lens compensates for the bending of the security element 1. The surface of the security element 1, which is covered with the Fresnel-like cylindrical lens structure as surface structure, lights up completely in the predefined bent state. FIGS. 11a and 11b show this with reference to a pattern with a volume hologram, applied to a black background. The volume hologram was created with a flat master with a Fresnel-like cylindrical lens structure as surface structure, which is designed for a predefined bent state with a curvature radius of approximately 38 mm. The volume hologram was produced by exposure with a green laser with a wavelength of 532 nm. FIG. 11a shows the photographed volume hologram in the flat state and FIG. 11b shows the photographed volume hologram in the predefined bent state with the curvature radius of approximately 38 mm. The curvature around the bending point is symmetrical here. In the flat state substantially only the area which lies in the bending point lights up. In the predefined bent state, on the other hand, a larger surface lights up around the bending point. This can be used, among other things, as a design element, e.g. as a frame around another design element, wherein this frame focuses the observer's attention on this area in the predefined bent state of the security element 1. The frame in FIG. 9b is a specific example of this. Such Fresnel-like cylindrical lens structures can be produced e.g. by means of e-beam lithography. Preferably, the depth of the Fresnel-like cylindrical lens structure is adapted to the wavelength at which the volume hologram appears. For this a structure depth is selected, for example, which corresponds to half the wavelength of the entering light.

It is further also possible to produce the master 18 by means of distorting optics, in particular by means of cylindrical lenses. During the holographic production of a flat master, the beam path is here distorted by means of distorting optics such that the volume hologram to be inscribed in the volume hologram layer 11 is visible for the observer only in the bent state.

As shown in FIG. 10c, the structure from FIG. 10b is then exposed with a coherent light beam 19. The coherent light beam 19, for example a laser beam of wavelength 640 nm, passes through the carrier layer 16 and the volume hologram layer 11 and is deflected or reflected back and/or diffracted back at the surface structure of the opaque master 18. In the volume hologram layer 11 the deflected or diffracted light beams 20 interfere with the incident light beam 19, with the result that in this way a volume hologram is introduced into the volume hologram layer 11. In the zones 10g the volume hologram here has Bragg planes 12, which are aligned at different angular positions relative to each other. The different alignment of the Bragg planes 12 in the zones 10g here arises due to the deflection of the light 20 into different directions brought about by the surface structure. The distances between the Bragg planes are substantially determined by the wavelength of the exposure. The volume hologram is then fixed by curing of the volume hologram layer 11. This can be effected, for example, by irradiation with UV light.

It is further possible that the master 18 has at least two partial areas which reflect or diffract incident light into at least two different zones of the volume hologram layer 11. The partial areas are here designed such that they reflect and/or diffract the incident light at a predetermined angular position which is determined such that the desired alignment of the Bragg planes forms in the volume hologram layer 11. The angular positions into which the at least two partial areas reflect and/or diffract the incident light beam are thus different for one thing and, for another thing also depend on the angular position at which the coherent light beam 19 is radiated onto the at least two partial areas. The desired orientation of the Bragg planes 12 in the predefined bent state of the security element 1, as well as the structure of a predetermined holographic exposure device here determine the deflection angle of the at least two partial areas. By deflection angle is meant here the angle by which the surface structure of the master 18 in the respective partial area deflects a perpendicularly incident light beam from the surface normal by reflection and/or diffraction.

Preferably, the surface structures of the master 18 comprise a Kinegram®, linear or crossed sinusoidal grating, anisotropic or isotropic matte structures, lens structures, Fresnel-like freeform surfaces, kinoform structures or computer-generated holograms, a symmetrical grating, an asymmetrical grating, in particular a blazed grating, microstructures with a predominantly refractive effect such as for example micromirrors, a binary grating, a multi-level phase grating or combinations thereof. Further, grating structures with statistically varying parameters (grating period, profile shape, grating depth, azimuthal alignment) can be provided here. In particular, blazed gratings or microstructures with a predominantly refractive effect are suitable, the flank angles of which are designed for the illumination and observation angles of the corresponding zones of the security element in the predefined bent state.

It can be provided that the volume hologram layer 11 and the master 18 are exposed by coherent light beams 19, in particular by light beams generated by a laser, of different wavelengths and/or different angles of incidence. In this way it can be achieved that the items of information produced by the volume hologram appear in different colors and/or are visible in the case of different observation situations in the bent state of the security element.

It can be provided that the surface structures of the master 18 in part provide no information. The areas of the master 18 which provide no information can, for example, be used as background structure. Such background structures can, for example, be formed such that scattered light and/or disruptive reflections are reduced. This can be achieved in that the areas of the master 18 which contain no image information are formed as a moth-eye structure, in particular crossed grating structures (quadratic or hexagonal) or statistical structures with a high number of lines or spatial frequencies (for example more than 2000 lines/mm, in particular more than 3000 lines/mm) and/or as a mirror and/or as a matte structure and/or as a scatter grating. Anti-reflective structures or structures further optimized specifically for the purpose can also be used for this.

Preferably, the surface structure of the master 18 differs in the at least two partial areas, in particular the surface structure of the master 18 differs in at least one of the parameters: profile shape, grating depth, grating period and azimuthal angle in the at least two partial areas, wherein these parameters can also be defined via statistical distribution functions.

It can further be provided that the master 18 has a symmetrical grating structure in a first partial area and a first asymmetrical grating structure in a second partial area, in particular a blazed grating, wherein the grating periods and/or grating depths of the grating structures in the first and second partial areas differ. Further, the master 18 can have a second asymmetrical grating structure, in particular a blazed grating, in a third partial area, wherein the grating periods and/or the grating depths of the first and second asymmetrical grating structures differ. It is thus possible, for example, that the grating period is 600 lines/mm in the first partial area, the grating period is 300 lines/mm in the second partial area and is 100 lines/mm in the third partial area.

After curing of the volume hologram layer 11, as shown in FIG. 10d, the master 18 is removed and an adhesive layer 15 can then be applied to the side of the volume hologram layer 11 facing away from the carrier layer 16, by means of which the security element 1 with the volume hologram introduced into the volume hologram layer 11 can be applied to a substrate, in particular a flexible substrate. It is hereby possible, for example, to apply the security element 1 to a security document, for example a banknote. Before applying the adhesive layer, another further sealing layer formed as a transparent or also as a transparent dyed layer is preferably applied to the volume hologram layer 11.

FIG. 12 schematically shows an example of use of a security element 1. As explained above, the security element 1 is here applied to a security document 2, for example a banknote. The security element 1 comprises a volume hologram layer into which a volume hologram is introduced. The volume hologram is here designed such that in the case of a bending into the predefined bent end state E of the security element 1 shown in FIG. 12 an item of information is sequentially completed for the observer 7 in the observation situation shown in FIG. 12. The bent states Z, E shown in FIG. 12 are characterized in that the security element 1 to the left of the bending point 9 is not bent and the security element 1 to the right of the bending point 9 is bent towards the observer 7 as far as into the predefined bent end state E. A part of the item of information is here produced by a zone 10h of the volume hologram which is situated to the left of the bending point 9. This part of the item of information is thus always visible for the observer 7 in the observation situation shown in FIG. 12 and remains unchanged. The part of the item of information produced by the zone 10h is therefore also visible for the observer 7 in the unbent state U. If the security element to the right of the bending point 9, as shown in FIG. 12, is bent towards the observer, further parts of the item of information thus appear to the observer 7 sequentially until the complete item of information is visible for the observer 7 in the predefined bent end state E. These further partial items of information are produced by zones 10i, 10j to the right of the bending point 9. Thus, for example, during bending as far as into the predefined end state E, a building such as a skyscraper can appear piece by piece to the observer 7, wherein only the first floor, for example, is recognizable for the observer in the unbent state of the security element U, 60% of the building, for example, is visible in the bent intermediate state Z and the building is completely visible in the bent end state E.

FIG. 13a to FIG. 13i schematically show examples of use of security elements 1. As is shown in FIG. 13a to FIG. 13i, the security elements 1 are arranged on the security documents 2. FIG. 13a to FIG. 13i here show possible optically variable effects of security elements 1 in bent and unbent states.

Thus FIG. 13a shows an optical effect which is perceptible for the observer during bending of the security element 1 around the horizontal axis into a convex shape. The bending variant thus corresponds to the bending variant 810 of FIG. 8. As described above, the security element 1 has a volume hologram layer into which a volume hologram is introduced, wherein the volume hologram is formed such that an item of information 21 is visible for an observer in an observation situation in a predefined bent state of the security element 1 and is not visible or not recognizable in the observation situation in the unbent state of the security element 1. Only the letter B is comparatively clearly recognizable for the observer in the unbent state of the security element 1. This is due to the letter B being arranged in a zone of the security element 1 which undergoes no, or only a slight change in shape during the bending into the predetermined bent state of the security element 1. The Bragg planes in the zone of the volume hologram layer forming the letter B are thus aligned such that the letter B is visible for the observer both in the unbent state and in the predefined bent state. If the security element 1 is bent into the predetermined bent state, further items of information 21 are perceptible for the observer. The Bragg planes in the zones forming the items of information 21 are thus aligned such that the letters A and C are visible and comparatively clearly recognizable for the observer in the bent state.

FIG. 13b also shows an optical effect which is perceptible for the observer during bending of the security element 1 around the horizontal axis into a convex shape. Here too, the letter B is comparatively clearly recognizable in the unbent and in the predefined bent states. In contrast to FIG. 13a, in a first predefined bent state of the security element 1, in addition to the letter B, only the item of information 22 which represents the letter A appears to the observer. During a further bending into a second predefined state of the security element 1 the item of information 22 disappears; however, in addition to the letter B, the item of information 40 which represents the letter C is now recognizable for the observer. In this case, the volume hologram thus has two items of information 22, 40 which are visible or comparatively clearly recognizable for the observer in two different bent shapes.

FIG. 13c corresponds to FIG. 13b with the difference that the letter A is now recognizable for the observer both in the unbent state and in the two bent states. In contrast to FIG. 13b, the items of information 23, 41 are here situated on the same side of the bending line of the security element 1. Further, the item of information 23 which represents the letter B is now comparatively clearly recognizable in the first predefined bent state and the item of information 41 which represents the letter C is comparatively clearly recognizable in the second predefined state. Such a security element 1 can, for example, be produced by means of a master, the surface structure of which has symmetrical and asymmetrical blazed gratings. The azimuthal angle of the gratings can, for example, be 0°, wherein the line density is adapted corresponding to the curvature of the security element 1 in the bent states. For example, the line density can be 600 lines/mm in the partial area which is to represent the letter A in the volume hologram to be inscribed and can be 1000 lines/mm in the partial area which is later to represent the letter B. The line density can, for example, be 1400 lines/mm in the partial area which is subsequently to represent the letter C in the volume hologram to be inscribed by means of the master.

FIG. 13d corresponds to FIG. 13b with the difference that the items of information 24 and 42 light up in different colors in each case. As already explained, this can be achieved during the production of the security element 1, for example through an exposure by coherent light beams of different wavelengths and/or different exposure angles. It is also possible that the surface structure of the master used for the production has different grating structures in the corresponding partial areas, which differ in particular in the parameters: grating depth, grating period, profile shape and azimuthal angle, wherein these parameters can also be defined via statistical distribution functions and produce the volume holograms with different color perceptions.

FIG. 13e shows an optical effect which is perceptible for the observer during bending of the security element 1 around the horizontal axis into a convex shape. As shown in FIG. 13e, here the items of information 25, which here represent the letters A and C, change the color during a bending of the security element 1. Thus, during a bending the motif does not change for the observer, or no new motif appears to the observer, rather only the color impression of the perceptible item of information changes. Such an effect can, for example, be achieved by two volume holograms gridded in each other. As explained above, the first volume hologram is formed such that the items of information 25 are visible for the observer in a different color in the bent state of the security element 1 than in the unbent state. The second volume hologram is a volume hologram which is designed such that the items of information 25 are already visible in the unbent state of the security element 1. However, the item of information 25 produces a different color perception for the observer in the unbent state of the security element 1 than in the bent state. The first volume hologram is preferably arranged in at least one first area of the volume hologram layer and the second volume hologram in at least one second area of the volume hologram layer, wherein the at least one first and second areas are gridded in each other. Further, such an effect can be achieved by a first and a third volume hologram, wherein the first and the third volume holograms are introduced into two volume hologram layers which are arranged one above the other. As already explained, the first volume hologram is formed in the first volume hologram layer such that, for the observer, a color change of the motif takes place during a bending of the security element 1 with respect to the motif produced by the third volume hologram. Advantageously, the first volume hologram in the first volume hologram layer and the third volume hologram in the second volume hologram layer are aligned with register accuracy relative to each other.

FIG. 13f corresponds to FIG. 13e with the difference that it is not the color impression of the item of information that changes, but rather the motif of the item of information 26. As shown in FIG. 13f, the letters A and C recognizable for the observer become a portrait or a geometric figure in the unbent state. Such a motif or image flip can, for example, be achieved by the gridding of two holograms. Here, preferably, one hologram, which produces the letters A and C, is exposed in the flat state, i.e. as a flat substrate or master, and the other hologram, which produces the portrait and the triangle, is exposed in the curved state, i.e. on a curved substrate or master for the predefined bent state. Furthermore, it is additionally possible that the color perception changes as explained above.

FIG. 13g corresponds to FIG. 13a with the difference that the security document 2 has a print 60, which is supplemented during a bending of the security element 1 in a predefined bent state by the items of information 27 of the volume hologram then visible for the observer. The volume hologram and the print are here aligned with register accuracy relative to each other. It is also possible that the print 60 shows the item of information which becomes visible for the observer during a bending into the predefined bent state of the security element 1. It is further possible that the security element 1 is applied to a print 60 already applied to the security document 2. The print 60 can here again show the item of information which becomes visible for the observer during a bending into the predefined bent state of the security element 1, or the item of information of the print and that of the volume hologram complement each other. In the two last-named cases, the print thus forms a reference for the item of information which is recognizable for the observer only in the bent state of the security element 1. Print and volume hologram are preferably designed such that a word is completed during the bending of the security document. For example, from the character sequence “ban . . . ote”, the word “banknote” appears.

FIG. 13h shows a security document 2 with a security element 1, wherein the security element 1 shows two different items of information 28, 43 in two different bent states. The items of information 28 are recognizable for the observer in a first bent state which corresponds to a bending of the security element 1 around the horizontal axis into a concave shape for the observer. The items of information 43 are recognizable for the observer in a second bent state of the security element which corresponds to a bending of the security element 1 around the horizontal axis into a convex shape for the observer, wherein, as already described above, the colors of the letters A and C here again change between the first and second bent states. Alternatively, the motifs can of course also alter during the change from concave to convex bending shape. The bent states shown in FIG. 13h correspond to the bending variants 808 and 809 of FIG. 8.

FIG. 13i shows a security document 2 with a security element 1. In the unbent state the security element 1 produces, for the observer, a design with two dark rectangles, wherein the rectangles appear colored blue in front of a white background, for example. On the other hand, in the bent state of the security element 1 both the design recognizable for the observer and the color impression change. In the example shown in FIG. 13i, the dark rectangles disappear and a color impression in the form of strips, for example of two red strips and one white strip, is produced for the observer. With respect to the design of the security element 1, in particular the volume hologram layer of the security element 1, reference is made here to the above statements. Further, the security element 1 has a reflective layer in the square areas 50.

As shown in FIG. 13i, the reflective layer can be arranged above the volume hologram layer, but it can also be arranged under the volume hologram layer.

The reflective layer is preferably a metal layer made of aluminum, chromium, gold, copper, silver or an alloy of such metals which is vapor-deposited under vacuum in a layer thickness of 0.01 μm to 0.15 μm. The reflective layer is here preferably applied over the whole surface first. Then the reflective layer is removed again in areas of the surface by means of known structuring processes (by means of etch resist, by means of photoresist, by means of washing processes), with the result that a partial metallization occurs in the areas 50. As shown in FIG. 13i, the areas 50 form a motif, for example in the form of squares. The areas 50 are thus visible for the observer independently of the bending of the security element 1 and thus complement each other with the effects of the security element 1 which show a dependence on the bending of the security element 1.

FIG. 13j shows a security document 2 with a security element 1. The security element 1 here shows optical effects which show both a dependence on a tilting of the security element 1 and a dependence on a bending of the security element 1. If the security element 1 in the unbent state is tilted around the vertical axis, as shown in FIG. 13i, an item of information 29u in the form of a two-dimensional motif is always recognizable for the observer. If the security element 1 is bent around the horizontal axis and tilted around the vertical axis, as shown in FIG. 13i, an item of information 29 in the form of a three-dimensional impression of the motif emerges for the observer. The motif is thus dependent on the tilting of the security element 1 only in the bent state. With respect to the design of such a security element, reference is made here to the above statements, in particular in the context of FIG. 13d and FIG. 13e, wherein, in particular, the first volume hologram is designed such that it has a parallax and thus appears for the observer in front of the plane spanned by the security element 1 and the second volume hologram is formed such that it has no parallax and thus appears for the observer in the plane spanned by the security element 1. Alternatively, only the volume hologram which shows the item of information 29 in the bent state can also be provided. In the unbent state there is either nothing to be seen or only a blurred surface area without the item of information 29.

The volume hologram which in the bent state produces the item of information 29 in the form of the three-dimensional impression of the motif can, for example, be a CGH which has been calculated for a curved surface area such as is present in the bent state. Alternatively, this volume hologram can also be a 3D hologram which is based on a master which, as explained above, is based on an intermediate master exposed curved.

FIG. 14 schematically shows an example of use of a security element 1 with a volume hologram layer. In an area 51 a volume hologram, which is formed such that a complete item of image information is visible only in a bent state of the security element 1, is introduced into the volume hologram layer. As shown in FIG. 14, a part of the item of information 30u is already visible in the unbent state of the security element 1. Further, the security element 1 has a relief structure in the area 52. The area 52 is here designed patterned in the form of a flame motif. The relief structure is, for example, a binary or continuous Fresnel-like freeform surface, which is characterized in particular in that it does not change, or only slightly changes, its characteristic appearance during a bending of the security element 1.

If, as shown in FIG. 13, the security element 1 is now brought into the predefined bent state, the item of information 30 which complements the item of information 30u appears for the observer, and forms a complete frame around the area 52.

The security element 1 preferably has a replication varnish layer into which a relief structure is molded. The replication varnish layer consists, for example, of a thermoplastic varnish into which the relief structure is molded by means of heat and pressure through the action of a stamping tool. It is further also possible that the replication varnish layer is formed by a UV-crosslinkable varnish and the relief structure is molded into the replication varnish layer by means of UV replication. The relief structure is molded onto the uncured replication varnish layer through the action of a stamping tool and the replication varnish layer is cured directly during or after the molding, through irradiation with UV radiation. Such a replication varnish layer in particular has a layer thickness between 0.1 μm and 20 μm, preferably 0.2 μm and 10 μm, further preferably 0.4 μm and 5 μm. It is further possible here that the security element 1 has a reflective layer, in particular in the area 50. The reflective layer is preferably a metal layer made of aluminum, chromium, gold, copper, silver or an alloy of such metals which is vapor-deposited under vacuum in a layer thickness of 0.01 μm to 0.15 μm.

FIG. 15a to FIG. 15c schematically show the bending of a security document 2 with a security element 1. As shown in FIG. 14a, the security element 1 is applied to the substrate 17 by means of the adhesive layer 15. The substrate 17 is preferably a substrate 17 made of paper material, which is provided with printing and into which further security features, such as for example watermarks or security threads are introduced. The security element 1 further has a volume hologram layer 11 into which a volume hologram is introduced. The volume hologram here has the zones 10j and 10k, wherein the zones 10j provide a first item of information for the observer 7 in the predefined bent state of the security element 1 shown in FIG. 15b and the zones 10k provide a second item of information for the observer 7 in the predefined bent state of the security element 1 shown in FIG. 15c. Here, the observer 7 sees the security element 1, in each case in the same observation situation, wherein the bending of the security element differs only as shown in FIG. 15b and FIG. 15c. In the unbent state of the security element 1 shown in FIG. 15a the observer recognizes no item of information. If the security element 1 is bent into the first bent state shown in FIG. 15b, the observer 7 recognizes a first item of information produced by the zones 10j. The first item of information can, for example, be the motif of a closed flower blossom. As already explained, the Bragg planes in the zones 10j are here aligned such that the first item of information is visible for the observer 7 in the first predefined bent state. If the security element 1 is now bent further, as shown in FIG. 15c, the first item of information disappears for the observer 7, but the observer 7 can now recognize a second item of information, which is produced by the zones 10k. The second item of information can, for example, be an opened flower blossom. As already explained, the Bragg planes in the zones 10k are here aligned such that the second item of information is visible for the observer 7 in the second predefined bent state. Preferably, the bending radii in the first and the second predefined bent states of the security element 1 differ by at least 2 mm, preferably 5 mm, further preferably 10 mm.

FIGS. 16a and 16b schematically show the bending of a security document 2 with a security element 1. The security document 2 consists of a flexible substrate 17, to which the security element 1 is applied by means of an adhesive layer 15. The security element 1 further comprises a volume hologram layer 11, a reflective layer 17r as well as the varnish layers 17l1 and 17l2.

The varnish layer 17l1 is preferably a protective varnish layer. The varnish layer 17l1 is preferably transparent and has a layer thickness between 0.1 μm and 10 pm, preferably between 0.3 μm and 1 μm, further preferably between 0.5 μm and 1 μm. The varnish layer 17l2 is preferably a transparent spacing layer, which is arranged between the volume hologram layer 11 and the reflective layer 17r. The varnish layers 17l1 and 17l2 preferably comprise PMMA (=polymethyl methacrylate), PVC, acrylate or carnauba wax.

The reflective layer 17r is preferably a metal layer made of aluminum, chromium, gold, copper, silver or an alloy of such metals which is vapor-deposited under vacuum in a layer thickness of 0.01 μm to 0.15 μm. Alternatively, the reflective layer 17r can also be a printed or high-resolution structured color layer or another layer which absorbs radiation in the visible spectral range. As shown in FIGS. 16a and 16b, the reflective layer 17r is applied only in areas, with the result that there is a partial metallization or partial coating. For this, the reflective layer 17r can be applied over the whole surface first and then removed again in areas of the surface by means of known structuring processes (for example by means of etch resist, by means of photoresist, by means of washing processes). As shown in FIGS. 16a and 16b, the partially metalized reflective layer 17r is arranged according to a grid. The grid is preferably a line grid.

A volume hologram 11v is introduced into the volume hologram layer 11. As shown in FIGS. 16a and 16b, the volume hologram 11v is arranged in areas according to a grid, wherein the areas into which the volume hologram 11v is introduced into the volume hologram layer 11 are arranged congruent with the metalized areas of the reflective layer 17r. The areas with the volume hologram 11v are preferably arranged in register with the reflective layer. The grid is thus preferably also a line grid, which is arranged in particular with register accuracy with the line grid of the reflective layer 17r. With respect to the further design of the volume hologram layer 11 and of the volume hologram 11v, reference is made here to the above statements.

The adhesive layer 15 preferably comprises acrylates, PVC (=polyvinyl chloride), PUR (=polyurethane) or polyester and further preferably has a layer thickness between 0.1 μm and 20 μm, preferably between 0.1 μm and 10 μm, further preferably between 0.5 μm and 5 μm, even further preferably between 0.8 μm and 3 μm. The adhesive layer shown in FIGS. 16a and 16b has a layer thickness of 2 μm.

With respect to the design of the substrate 17, reference is made here to the above statements.

In the unbent state of the security element 1 shown in FIG. 16a the reflective layer 17r now covers the volume hologram 11v arranged in register therewith, with the result that the volume hologram 11v is largely not visible for an observer, in particular under normal lighting conditions and/or in the case of a normal observation distance and/or a normal observation angle, for example in the case of perpendicular or almost perpendicular observation. Incident light 19, which is diffracted and/or reflected by the volume hologram 11v, now cannot reach the observer, because of the reflective layer 17r, with the result that the volume hologram 11v is not visible, or almost not visible, for the observer.

On the other hand, in the predefined bent state of the security element 1 shown in FIG. 16b the reflective layer 17r now no longer completely covers the volume hologram 11v, in particular because of the deformation of the layers of the security element brought about by the bending of the security element, and the resulting displacement of the reflective layer 17r with respect to the volume hologram 11v, with the result that the partial areas of the volume hologram shown in FIG. 16b now become visible and light 14 diffracted and/or reflected by the volume hologram 11v can reach the observer past the reflective layer 17r. For the observer the volume hologram 11v is then at least partially visible in the predefined bent state of the security element 1. Light 19e incident on the security element 1 reaches the volume hologram 11v, through the partially metalized reflective layer 17r to is reflected and/or diffracted there and can now, because of the bending of the security element 1, reach the observer at least partially past the reflective layer 17r.

Preferably, the line widths and line spacings of the grids of the reflective layer 17r and/or of the volume hologram 11v and the layer thickness of the transparent spacing layer 17l2 are selected such that the visibility of the volume hologram 11v is maximized in the predefined bent state of the security element 1. As shown in FIGS. 16b and 16b, the lines of the line grids preferably run parallel, or predominantly parallel, to the bending line of the security element 1.

The line widths and line spacings of the grids of the reflective layer 17r and the corresponding line widths and line spacings of the volume hologram 11v are determined by geometric construction or mathematical calculation. These are based on the parameters defined in FIG. 17. For the sake of simplicity the case of a curvature with a constant bending diameter D is shown there. However, line grids and volume hologram can thus also be designed for any other curvature shape. Further important variables that are taken into account are the opening angles β and δ as well as the observation angle a and the observation distance h.

FIG. 18 shows the dependence of the thus-determined line widths and line spacings on the angle of curvature. In the flat area, in the case of very small angles of curvature very fine grid lines and very finely gridded volume holograms have to be provided. With an increasing angle of curvature the widths and spaces of the grids also increase. Typically, in the case of an angle of curvature of 45° the widths and spaces lie in the range of the thickness of the spacing layer. In the case of a thickness of the spacing layer of, for example, 10 μm the line spacings and line widths of the reflective layer and the corresponding line spacings and line widths of the volume hologram lie in the range of 10 μm.

In a variant, the spacing layer or the varnish layer 17l2 can be provided, as shown in FIGS. 16a and 16b, not with a constant thickness, but with a variable thickness. This is shown, for example, in FIG. 19. In particular, the thickness of the spacing layer increases. In particular, the thickness of the spacing layer changes perpendicularly to the bending line. In FIG. 19 the bending line extends out from the sheet plane. It is advantageous if the spacing layer has the greatest layer thickness in the area of the bending line or along the bending line, and the layer thickness decreases or becomes smaller with distance from the bending line. This means, in particular, that a larger layer thickness of the spacing layer is present in the area of small bending angles, and a smaller layer thickness of the spacing layer is present in the area of larger bending angles. In FIG. 19 the layer thickness of the spacing layer 17l2 decreases continuously starting from the bending line.

The advantage is that, due to the variation in the thickness of the spacing layer, the line widths and line spaces of the grids of the reflective layer 17r can be formed more uniform and the volume hologram 11v is thereby clearly visible at all points in the bent state and, in addition, the appearance of the metallization is more uniform.

In a variant, it can also be provided to provide the spacing layer or the varnish layer 17l2 not as a layer with a constant thickness or continuously varying thickness, but rather as a stepped layer, see FIG. 20.

In a further variant, it can be provided to use two or more spacing layers 17l2, 17l3 instead of a single spacing layer 17l2, and two or more partial reflective layers 17r1, 17r2 instead of a single partial reflective layer, see FIG. 21. Because at least two reflective layers 17r1, 17r2 are present, which are in particular offset laterally relative to each other, and the line widths and line spacings of which are adapted to the curvature, the line widths can be selected smaller and the line spacings larger. The volume hologram 11v is thereby more visible in the bent state and/or less visible in the unbent state.

FIG. 22a and FIG. 22b schematically show the bending of a security document 2 with a security element 1. The security document 2 consists of a flexible substrate 17, to which the security element 1 is applied by means of an adhesive layer 15. The security element 1 further comprises a volume hologram layer 11, the reflective layers 17r1 and 17r2 as well as the varnish layers 17l1, 17l2 and 17l3.

As shown in FIGS. 22a and 22b, the varnish layer 17l2, which preferably serves as a transparent spacing layer, is arranged between the reflective layers 17r1 and 17r2. A further varnish layer 17l3, which in particular serves as a transparent spacing layer, is optionally arranged between the reflective layer 17r3 and the volume hologram layer 11. The transparent spacing layers 17l2 and 17l3 preferably have a layer thickness between 1 μm and 50 μm, preferably between 2 μm and 10 μm. The transparent spacing layers 17l2 and 17l3 shown in FIGS. 22a and 22b have, for example, layer thicknesses of 5 μm. With respect to the further design of the layers 17l1, 17l2 and 17l3, reference is made here to the above statements.

As shown in FIGS. 22a and 22b, the reflective layers 17r1 and 17r2 are in each case formed in areas and in the form of a grid. The grid is preferably a line grid with line widths and/or line spacings between 1 μm and 50 μm, preferably between 2 μm and 10 μm. The line grid shown in FIGS. 22a and 22b has line widths and line spacings of 5 μm. The grids of the reflective layers 17r1 and 17r2 are offset relative to each other such that, in particular during observation perpendicular to a plane spanned by the volume hologram layer 11 in the unbent state of the security element 1, the non-metalized areas of the reflective layer 17r1 are covered by the metalized areas of the reflective layer 17r2 and vice versa. The two reflective layers 17r1 and 17r2 are, so to speak, positioned “with a gap” relative to each other. The two reflective layers 17r1 and 17r2 are therefore arranged relative to each other such that in the unbent state of the security element 1 they completely or almost completely cover the underlying volume hologram 11v introduced over the whole surface.

In the unbent state of the security element 1 shown in FIG. 22a, the volume hologram 11v is therefore substantially not visible for the observer.

On the other hand, in the predefined bent state of the security element 1 shown in FIG. 22b the reflective layers 17r1 and 17r2 no longer completely cover the volume hologram 11v, with the result that now, in particular because of the deformation of the layers of the security element brought about by the bending of the security element into the predefined bent state, light 14 diffracted and/or reflected by the volume hologram 11v can reach the observer past the reflective layers 17r1 and 17r2. For the observer, the volume hologram 11v is then at least partially visible in the predefined bent state of the security element 1.

Preferably, the line widths and line spacings of the grids of the reflective layers 17r1 and 17r2 and the layer thicknesses of the spacing layers 17l2 and 17l3 are selected such that the visibility of the volume hologram 11v is maximized in the predefined bent state of the security element 1. It is advantageous here if the layer thicknesses of the spacing layers 17l2 and 17l3 substantially correspond to the grid period of the line grids of the reflective layers 17r1 and 17r2. It is further possible that the line widths and/or line spacings vary, in particular depending on the predefined bent state of the security element 1. The line widths and spaces of the two line grids are in particular again determined by geometric construction, as described previously, or by calculation. As shown in FIGS. 22a and 22b, the lines of the line grids preferably run parallel to the bending line of the security element 1.

In a variant, the spacing layers 17l2 and 17l3 can be provided, as shown in FIGS. 22a and 22b, not with constant thicknesses, but with variable thicknesses. The advantage is that, due to the variation in the thickness of the spacing layers, the line widths and line spaces of the grids of the reflective layers 17r1 and 17r2 can be formed more uniform and the volume hologram 11v is thereby clearly visible at all points in the bent state and, in addition, the appearance of the metallization is more uniform.

In a further variant, it can also be provided to use three or more reflective layers instead of two reflective layers 17r1 and 17r2. Because at least three reflective layers are present, the line widths can be selected smaller and the line spacings larger. The volume hologram is thereby more visible in the bent state and less visible in the unbent state.

With respect to the further design of the layers 17r1 and 17r2 and the design of the layers 11, 15 and 17, reference is made here to the above statements.

FIG. 23 shows a security document 2, in particular a further variant of the layer structure in FIG. 22. Preferably, only one of the reflective layers 17r1 is formed as a line grid, whereas the other reflective layer 17r2 is formed as a gridded layer made of extensive grid elements. Preferably, the upper reflective layer 17r1 is designed as a line grid, whereas the lower reflective layer 17r2 is designed as a gridded layer made of extensive grid elements. However, the reverse case is also possible. The geometric shapes of the two reflective layers 17r1 and 17r2 as well as their dimensions result in particular through mathematical calculation, for example by means of software for the calculation of Moiré effects. The thickness of the varnish layer 17l2, which forms the spacing layer of the two reflective layers 17r1, 17r2, is in particular relevant for the calculation. As first target value, during the calculation it is for example predetermined that the Moiré effect in the flat state of the security element 1 produces a completely or almost completely non-transparent surface, as shown on the left in FIG. 24. The underlying volume hologram 11v is thereby covered in the flat state, and thus not visible or almost not visible. As second target value, it is for example predetermined that in the superimposed reflective layers the Moiré effect in the bent state of the security element 1 produces at least two windows or transparent areas which, for example, have the shape of the figures “3” and “5”, as shown on the right in FIG. 24. In these transparent areas the underlying volume hologram 11v, which is formed in the volume hologram layer, becomes visible.

FIG. 25 shows the top view of a detail of a layer formed as a line grid. In the case of a thickness of a spacing layer or varnish layer of 170 μm, for example, line widths of 70 to 90 μm (g, h) result, whereas the line spacings are 20 to 30 μm (e, f). FIG. 26 shows a top view of a detail of a gridded layer made of extensive grid elements. In the case of a thickness of a spacing layer or varnish layer of 170 μm, for example, structure widths of 10 to 70 μm (g, h) result, whereas the structure spaces are 10 to 80 μm (e, f).

FIG. 27 shows a further design of a security element 1. The security element shown in FIG. 27 has only one reflective layer 17r′. The reflective layer 17r′ substantially undertakes the function of the reflective layers 17r1, 17r2 shown in FIG. 22a, which are formed gridded and arranged offset relative to each other. In FIG. 27, the reflective layer 17r′ is present substantially as flanks. The reflective layer 17r′ therefore does not extend only in the xy-plane, but also extends in the z-direction. The reflective layer 17r′ formed in the form of flanks or the flanks have a similar effect to the louvers in a so-called “privacy filter” for computer screens. The light can pass through the reflective layer substantially perpendicularly, i.e. in the z-direction. As soon as a critical angle g is exceeded, the flanks of the reflective layer almost completely block the light coming from the volume hologram. However, for smaller angles the intensity of the volume hologram is also already reduced as at the critical angle g the light can now only pass out of a few points of the volume hologram.

FIGS. 28a to 28d show a possible production method for the security element 2 shown in FIG. 27. A louver-like or cup-shaped structure 62 is first replicated; the structure can be a varnish layer (FIG. 18a). The height H of the louvers 60 or cup edges can be between 1 μm and 50 μm, preferably between 2 μm and 20 rim, and particularly preferably between 2 μm and 10 μm. The distance d between the louvers 60 or cup edges should preferably be less than or equal to 10×H, better less than 5×H and even better less than 2×H. The replicated structure 62 is then vapor-deposited over the whole surface with a reflective layer, preferably with a thin metal layer 64, for example in a thickness of 20 nm to 30 nm, in particular with aluminum (FIG. 18b). In a demetalizing step, the reflective layer and/or the metal layer is then removed again in areas. The metal is substantially only removed in the recesses between the louvers 60 or the walls of the “microcups” i.e. only from the “bottom” of the structures. Elements 66 substantially formed in the form of flanks remain (FIG. 18c). The demetalizing step can in principle be carried out with all known demetalizing processes.

After the reflective layer 17r′ formed in the form of flanks is formed, another varnish layer can be applied to the reflective layer 17r′. The single-ply reflective layer 17r′ can then be combined with a volume hologram layer 11 and applied to a flexible substrate 17, such as a paper banknote (FIG. 18d). A layer 68 can be arranged between the reflective layer 17r′ and the volume hologram 11v. This layer 68 can be an adhesive layer and/or an adhesion-promoter layer. However, the layer 68 can also be dispensed with.

### LIST OF REFERENCE NUMBERS

1 security element
2 security document
3, 4, 5 coordinate axes x, y, z
6 tilting line, tilting point
7 observer
8 illumination device
9 bending line, bending point
10a, 10b, 10c, 10d, 10e, 10f, 10g, 10h, 10i zones
11 volume hologram layer
11v volume hologram
12 Bragg planes
13 incident light
14 diffracted and/or reflected light
15 adhesive layer
16 carrier layer
17 substrate
17l1, 17l2, 17l3 varnish layers
17r, 17r′, 17r1, 17r2 reflective layers
18 master
19 coherent light beam
19e incident light
20 deflected light beams
21, 22, 23, 24, 25, 26, 27, 28, 29, 30 first item of information
40, 41, 42, 43 second item of information
50, 51, 52 areas
60 louvers
62 louver-like structure
64 whole-surface metallization layer/reflective layer
66 demetallized layer/structured or reflective layer
68 layer
D bending diameter
β opening angle
δ opening angle
α observation angle
h observation distance
d distance between louvers
g critical angle
H height of louvers

1. A security element with a first volume hologram layer which spans a coordinate system with the coordinate axes x and y perpendicular to each other in an unbent state of the security element, wherein a first volume hologram is introduced into the first volume hologram layer in at least one first area, wherein the first volume hologram is formed such that a first item of information is visible for an observer in a first observation situation in a first predefined bent state of the security element and is not visible in the first observation situation in the unbent state of the security element or vice versa.

2. A security element according to claim 1, wherein the first volume hologram is formed such that at least one second item of information is visible for the observer in the first observation situation in at least one second predefined bent state of the security element and is not visible in the first observation situation in the unbent state of the security element or vice versa.

3. A security element according to claim 1, wherein, in the first and/or the at least one second predefined bent state, the security element is bent around the x-axis and/or the y-axis.

4. A security element according to claim 1, wherein, in the first and/or the at least one second predefined bent state, the security element is bent towards the observer such that the security element has a concave shape in the first and/or the at least one second predefined bent state, and/or wherein the security element is bent away from the observer such that the security element has a convex shape in the first and/or the at least one second predefined bent state.

5. A security element according to claim 1, wherein the security element has at least one bending line, around which the security element is bent in the first and/or the at least one second predefined bent state of the security element.

6. A security element according to claim 5, wherein the security element is bent symmetrically or asymmetrically with respect to the bending line in the first and/or the at least one second predefined bent state.

7. A security element according to claim 5, wherein the angles enclosed between a surface of the security element and one of the coordinate axes x or y are different on both sides of the bending line in the first and/or the at least one second predefined bent state of the security element when the security element is observed parallel to a plane spanned by the coordinate axes x and y.

8. A security element according to claim 5, wherein the angles enclosed between a surface of the security element and one of the coordinate axes x or y are substantially identical on both sides of the bending line in the unbent state of the security element when the security element is observed parallel to a plane spanned by the coordinate axes x and y), differ by less than 5°.

9. A security element according to claim 1, wherein, if the Laplace operator Δ is applied to a surface of the security element described by a function F(x,y), a predefined limit value is exceeded in the first and/or the at least one second predefined bent state of the security element and is not exceeded in the unbent state, wherein the function F(x,y) describes the distance from the surface of the security element to a two-dimensional reference surface spanned by the coordinate axes x and y.

10. A security element according to claim 1, wherein, the bending radius in the first and/or the at least one second predefined bent state of the security element lies between 1 mm and 100 mm.

11. A security element according to claim 2, wherein the bending radius in the first and the at least one second predefined bent state of the security element differs by at least 2 mm.

12. A security element according to claim 1, wherein, in the direction of the coordinate axis x or y around which the security element is bent in the first and/or the at least one second predefined bent state, the security element has a length of at least 5 mm.

13. A security element according to claim 1, wherein, in the at least one first area the first volume hologram has two or more first zones wherein the two or more first zones in the first predefined bent state of the security element provide the first item of information for the observer in the first observation situation.

14. A security element according to claim 2, wherein, in the at least one first area, the first volume hologram has two or more second zones, wherein the two or more second zones in the at least one second predefined bent state of the security element provide the at least one second item of information for the observer in the first observation situation.

15. A security element according to claim 13, wherein the two or more first zones and/or the two or more second zones have a length in the unbent state of the security element of at least 5 μm, in the direction of one of the coordinate axes x and/or y.

16. A security element according to claim 13, wherein the two or more first zones and/or the two or more second zones have an areal extent in the unbent state of the security element of at least 5 μm×5 μm.

17. A security element according to claim 13, wherein the two or more first zones and/or the two or more second zones are arranged according to a grid.

18. A security element according to claim 17, wherein the grid is a one-dimensional line grid, or a two-dimensional dot grid.

19. A security element according to claim 5, wherein in the at least one first area, the first volume hologram has two or more first zones, wherein the two or more first zones in the first predefined bent state of the security element provide the first item of information for the observer in the first observation situation, and wherein the two or more first zones and/or the two or more second zones are arranged on both sides of the bending line.

20. A security element according to claim 13, wherein in the first predefined bent state of the security element the two or more first zones and/or in the at least one second predefined bent state of the security element the two or more second zones are visible at different illumination angles and observation angles for the observer in the first observation situation.

21. A security element according to claim 1, wherein the first volume hologram layer has Bragg planes formed by refractive index variations.

22. A security element according to claim 21, wherein, in the at least one first area, the first volume hologram has two or more first zones wherein the two or more first zones in the first predefined bent state of the security element provide the first item of information for the observer in the first observation situation and wherein at least one of the parameters: distance between the Bragg planes and alignment of the Bragg planes differs in the two or more first zones and/or in the two or more second zones.

23. A security element according to claim 22, wherein the distance between the Bragg planes differs by more than 5 nm, and/or wherein the angles enclosed by the Bragg planes and the first volume hologram layer differ by more than 2°.

24. A security element according to claim 21, wherein, in the at least one first area, the first volume hologram has two or more first zones wherein the two or more first zones in the first predefined bent state of the security element provide the first item of information for the observer in the first observation situation and wherein the alignments of the Bragg planes in the two or more first zones are substantially identical to each other in the first predefined bent state of the security element.

25. A security element according to claim 21, wherein, in the at least one first area, the first volume hologram has two or more first zones wherein the two or more first zones in the first predefined bent state of the security element provide the first item of information for the observer in the first observation situation and wherein the alignments of the Bragg planes in the two or more second zones are substantially identical to each other in the second predefined bent state of the security element.

26. A security element according to claim 1, wherein a second volume hologram is introduced into the first volume hologram layer in at least one second area.

27. A security element according to claim 25, wherein the second volume hologram is formed such that a third item of information is visible in the first observation situation in the unbent state of the security element.

28. A security element according to claim 26, wherein the at least one first area is arranged alternating with the at least one second area, and wherein the at least one first area is arranged adjacent to the at least one second area.

29. A security element according to claim 1, wherein the security element has a third volume hologram in a second volume hologram layer.

30. A security element according to claim 29, wherein, in the unbent state of the security element, the first volume hologram layer and the second volume hologram layer are arranged one above the other during observation perpendicular to a plane spanned by the first volume hologram layer of the security element.

31. A security element according to claim 29, wherein the third volume hologram is formed such that a fourth item of information is visible for an observer in the first observation situation in a third predefined bent state of the security element and is not visible in the first observation situation in the unbent state of the security element or vice versa.

32. A security element according to claim 1, wherein the security element in at least one third area comprises a relief structure selected from the group: diffractive grating, Kinegram® or hologram, blazed grating, binary grating, multi-level phase grating, linear grating, crossed grating, hexagonal grating, asymmetrical or symmetrical grating structure, retroreflective structure, binary or continuous freeform surfaces, diffractive or refractive macrostructure, lens structure or microprism structure, microlens, microprism, zero-order diffraction structure, moth-eye structure or anisotropic or isotropic matte structure, or a superimposition or combinations of two or more of the above-named relief structures.

33. A security element according to claim 1, wherein the security element comprises at least one reflective layer in at least one fourth area.

34. A security element according to claim 33, wherein the reflective layer or at least one of the reflective layers is formed in the form of a grid.

35. A security element according to claim 34, wherein the first volume hologram is formed in the form of a grid, wherein the areas of the first volume hologram are arranged congruent in register with the areas of the reflective layer and wherein the first volume hologram is arranged below the reflective layer in the observation direction of the security element.

36. A security element according to claim 34, wherein the security element (1) has two partially metalized reflective layers in the form of a grid, which are arranged such that transparent, areas of one reflective layer are covered by metalized areas, of the other reflective layer, during observation perpendicular to a plane spanned by the first volume hologram layer in the unbent state of the security element.

37. A security element according to claim 33, wherein a transparent spacing layer is arranged between the volume hologram layer and the reflective layer and/or between the reflective layers.

38. A security element according to claim 37, wherein the layer thickness of the spacing layer varies.

39. A security element according to claim 33, wherein the reflective layer is formed in the form of flanks.

40. A security element according to claim 1, wherein the first and/or the at least one second and/or the third and/or the fourth item of information represents one or more symbols, logos, motifs, images, signs or alphanumeric characters.

41. A security element according to claim 1, wherein the first and/or second volume hologram layer has a layer thickness between 3 μm and 100 μm.

42. A security element according to claim 1, wherein the first and/or second volume hologram layer is formed from a photopolymer, silver halide emulsions or dichromatic gelatin.

43. A security element according to claim 1 wherein the security element is bendable, such that the shape of the security element can be changed by the application of force.

44. A method for producing a security element with a first volume hologram layer according to claim 1, wherein the method comprises the following steps:
a) providing the first volume hologram layer;
b) arranging a first master with a first surface structure on the first volume hologram layer;
c) exposing the first master and the first volume hologram layer by means of coherent light, wherein the first volume hologram introduced into the first volume hologram layer in this way is formed such that a first item of information is visible for an observer in a first observation situation in a first predefined bent state of the security element and is not visible in the first observation situation in the unbent state of the security element or vice versa.

45. A method according to claim 44, wherein the first volume hologram introduced in step c) is formed such that at least one second item of information is visible for the observer in the first observation situation in at least one second predefined bent state of the security element and is not visible in the first observation situation in the unbent state of the security element or vice versa.

46. A method according to claim 44, wherein in step b) a first master is used which is generated starting from a bent intermediate master, wherein the bending of the bent intermediate master corresponds to the bending of the first and/or of the at least one second predefined bent state of the security element.

47. A method according to claim 44, wherein, in step b) a first master (18) is used which is produced by means of cylindrical lenses.

48. A method according to claim 44, wherein, in step b) a first master is used the first surface structure of which comprises a Kinegram®, a symmetrical grating, an asymmetrical grating, a blazed grating, a binary grating, a multi-level phase grating, isotropic or anisotropic matte structures, a retroreflective structure, a macrostructure with a refractive effect, a microprism structure or micromirror, Fresnel-like freeform surfaces, or combinations thereof.

49. A method according to claim 44, wherein, in step b) a first master is used, which has at least two partial areas which reflect or diffract incident light into at least two different zones of the first volume hologram layer.

50. A method according to claim 49, wherein the first surface structure of the first master differs in the at least two partial areas, in at least one of the parameters: profile shape, grating depth, grating period and azimuthal angle.

51. A method according to claim 49, wherein the first master has a symmetrical grating structure in a first partial area, and has a first asymmetrical grating structure in a second partial area, wherein the grating periods and/or grating depths of the grating structures in the first and second partial areas differ.

52. A method according to claim 49, wherein the first master has a second asymmetrical grating structure in a third partial area, wherein the grating periods and/or grating depths of the first and second asymmetrical grating structures differ.

53. A method according to claim 44, wherein, in step c) the first volume hologram layer and the first master are exposed by coherent light beams of different wavelengths and/or different directions of incidence.

54. A method according to claim 44, wherein, in step c) the coherent light beam passes through the first volume hologram layer and is diffracted or reflected at the first surface structure of the first master.

55. A method according to claim 44, wherein, in step b) the first master is arranged on the first volume hologram layer directly or with the interposition of a transparent optical medium.

56. A method according to claim 44, wherein the exposure is effected with laser light with a power density in the range from 0.5 to 5 W/cm².

57. A method according to claim 44, wherein, after the exposure the first volume hologram layer is fixed by curing, by means of UV radiation.

58. A security document with a security element according to claim 1.

59. A security document according to claim 58, wherein the security document is formed as an identity document, passport document, visa, credit card, banknote, security or the like.
